(19) United States
(12) Patent Application Publication
(10) Pub. No.: US 2026/0039681 A1
(43) Pub. Date: Feb. 5, 2026

(54) METHODS TO DETECT DNS HIJACKING

(71) Applicant: Palo Alto Networks, Inc., Santa Clara, CA (US)

(72) Inventors: Janos Szurdi, Sunnyvale, CA (US); Mohammad Ghasemisharif, San Jose, CA (US); Daiping Liu, Santa Clara, CA (US); Zhanhao Chen, Sunnyvale, CA (US); Rebekah Houser, Sunnyvale, CA (US); Fan Fei, Pleasanton, CA (US); Arun Bala Kumar, San Jose, CA (US); Yu-Hsiang Kao, San Jose, CA (US)

(21) Appl. No.: 19/224,284

(22) Filed: May 30, 2025

Related U.S. Application Data
(60) Provisional application No. 63/101,185, filed on Jul. 31, 2024.
(60) Provisional application No. 63/730,760, filed on Dec. 11, 2024.

(51) Int. Cl. H04L 9/40; H04L 41/16

(52) U.S. Cl. CPC H04L 63/1433; H04L 41/16; H04L 63/1425; H04L 63/20

(57) ABSTRACT

The present application discloses a method, system, and computer system for detecting DNS hijacking records. The method includes (i) obtaining passive DNS (pDNS) data pertaining to a set of resource records, (ii) extracting a first set of features based at least in part on the pDNS data for a selected resource record, wherein the selected resource record is selected from the set of resource records, (iii) using a classifier to determine whether a candidate record corresponding to the selected resource record is a result of a DNS hijacking based at least in part on the first set of features, and (iv) performing an active measure in response to determining that the candidate record is the result of the DNS hijacking.

### CROSS REFERENCE TO OTHER APPLICATIONS

This application claims priority to U.S. Provisional Patent Application No. 63/101,185 entitled METHODS TO DETECT DNS HIJACKING filed Jul. 31, 2024 which is incorporated herein by reference for all purposes, and claims priority to U.S. Provisional Patent Application No. 63/730,760 entitled METHODS TO DETECT DNS HIJACKING filed Dec. 11, 2024 which is incorporated herein by reference for all purposes.

### BACKGROUND OF THE INVENTION

The Domain Name System (DNS) is a critical component of the internet infrastructure, translating human-readable domain names (e.g., www.example.com) into IP addresses that computers use to identify each other on the network. DNS hijacking, also known as DNS redirection, is a malicious attack in which the DNS settings are changed to redirect traffic to fraudulent services (e.g., websites). This can lead to severe consequences, including the theft of sensitive information, financial losses, and damage to the reputation of the targeted entities.

DNS hijacking can occur through various methods, such as compromising DNS servers, stealing accounts at domain registrars, altering DNS settings on individual computers, or exploiting vulnerabilities in network equipment. Once a DNS record has been hijacked, users attempting to visit a legitimate service (e.g., a website) are instead directed to a malicious service (e.g., site), often without their knowledge. This type of attack is particularly insidious because it can be difficult to detect.

Detecting DNS hijacking using passive DNS is challenging as a few malicious records need to be identified from hundreds of billions of DNS records. As detection is so challenging, traditional defensive methods aim at preventing DNS hijacking by fixing vulnerabilities and hardening user accounts (e.g., using two factor authentication).

### BRIEF DESCRIPTION OF THE DRA WINGS

Various embodiments of the invention are disclosed in the following detailed description and the accompanying drawings.

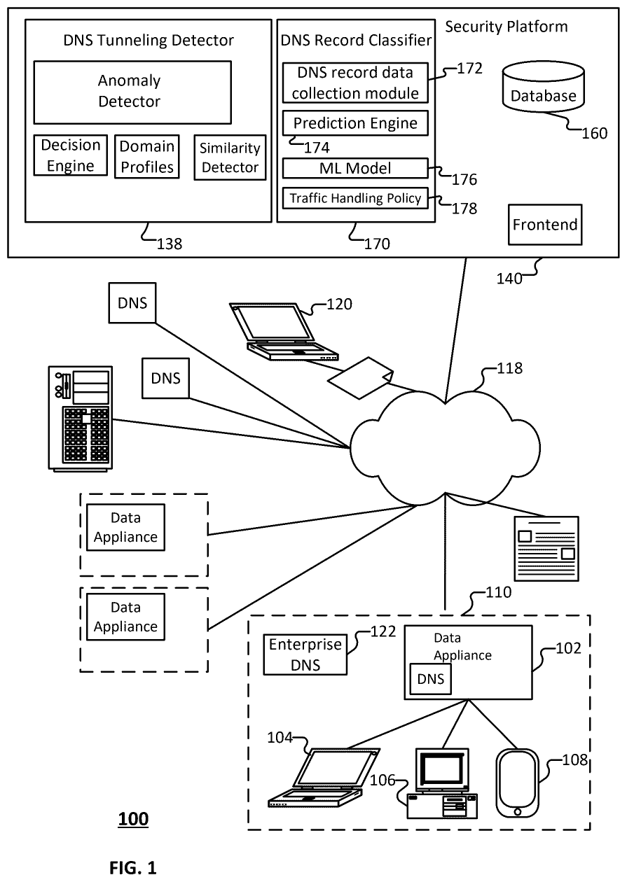

FIG. 1 is a block diagram of an environment in which a malicious domain or record is detected or suspected according to various embodiments.

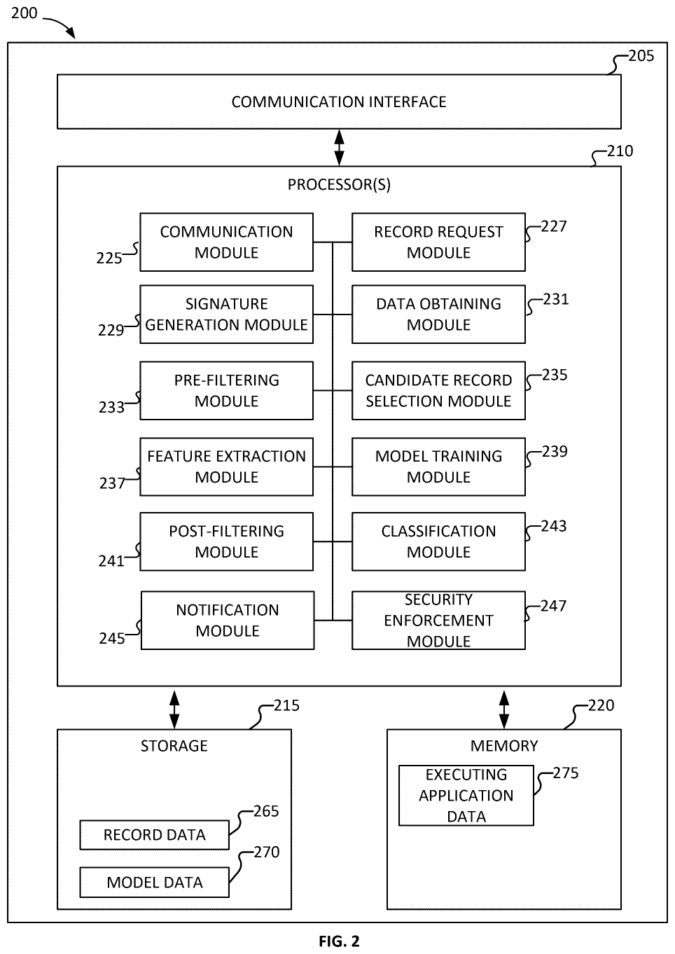

FIG. 2 is a block diagram of a system to detect a malicious record according to various embodiments.

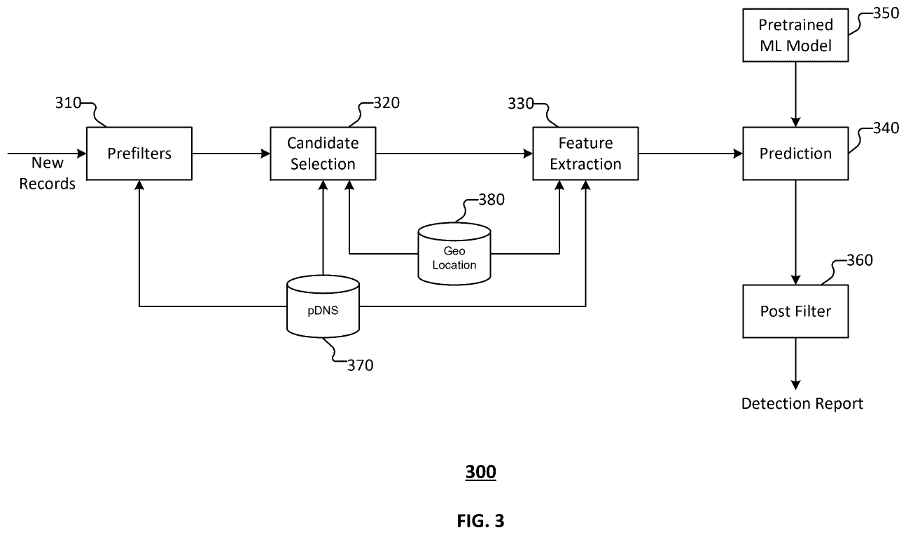

FIG. 3 is an illustration of a system for detecting a DNS hijacking records according to various embodiments.

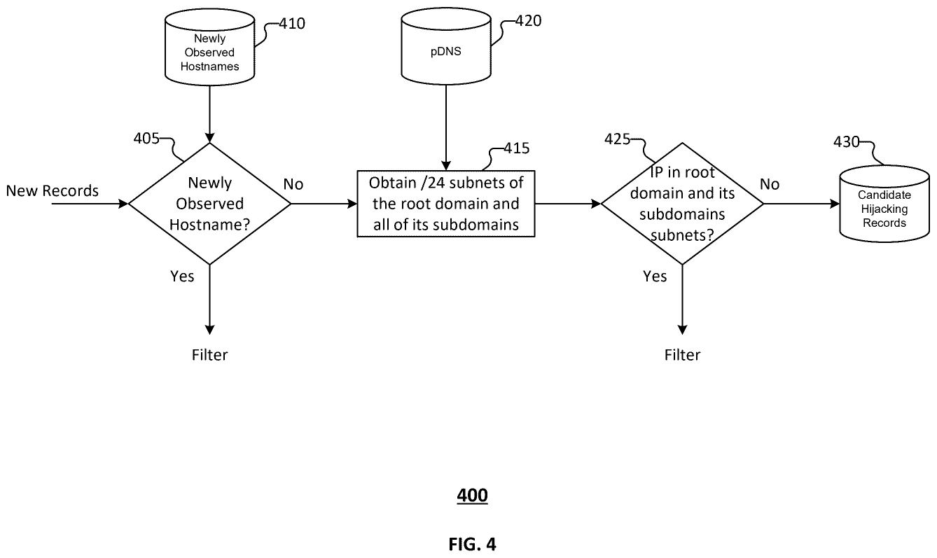

FIG. 4 is an illustration of a service for selecting a candidate record according to various embodiments.

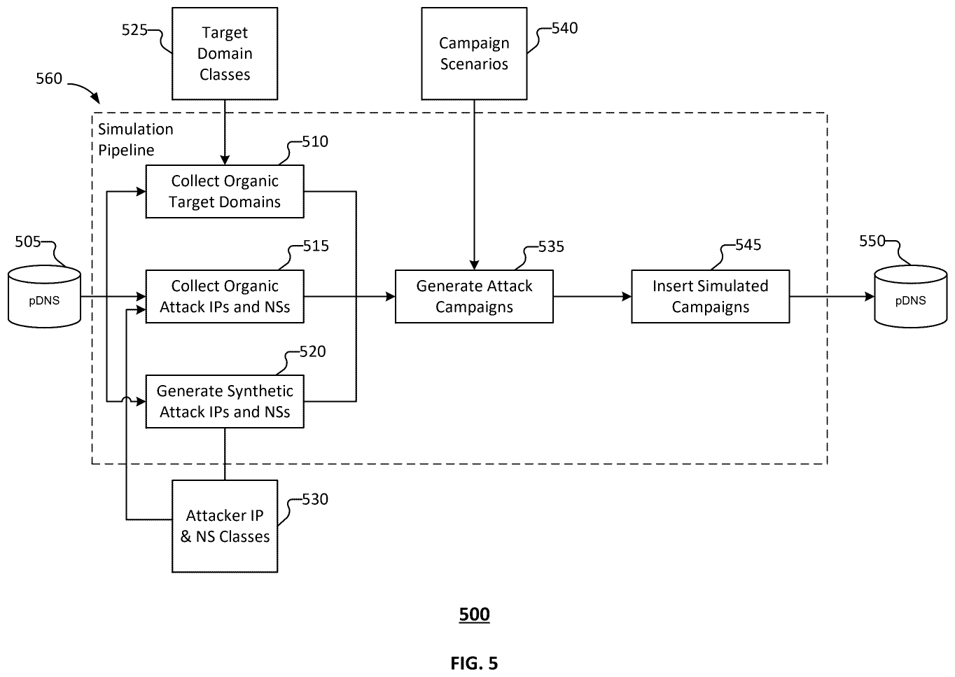

FIG. 5 is an illustration of a system for generating simulated DNS hijacking records according to various embodiments.

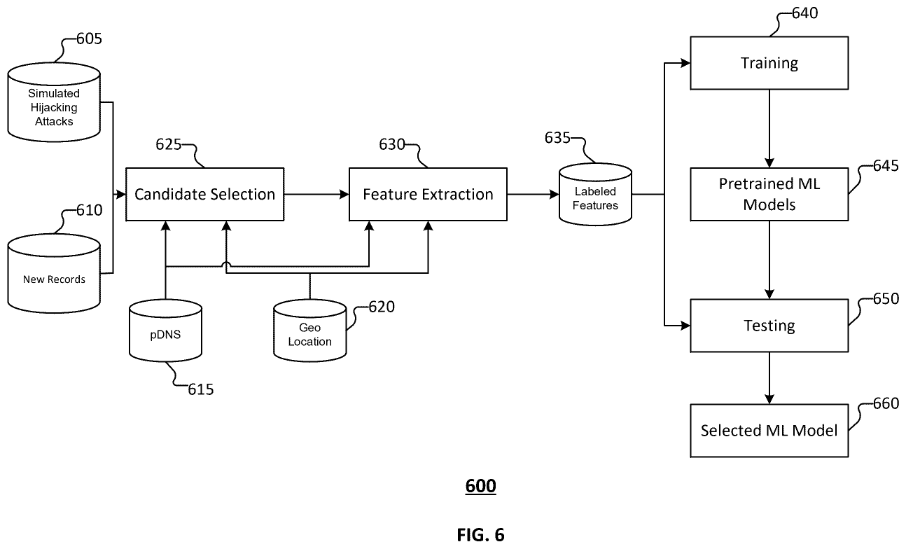

FIG. 6 is an illustration of a system for training a classifier according to various embodiments.

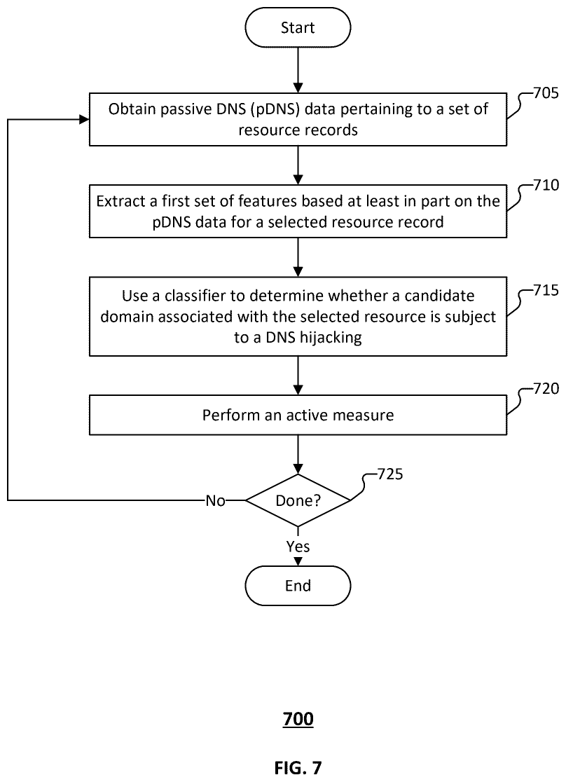

FIG. 7 is a flow diagram of a method for classifying a record according to various embodiments.

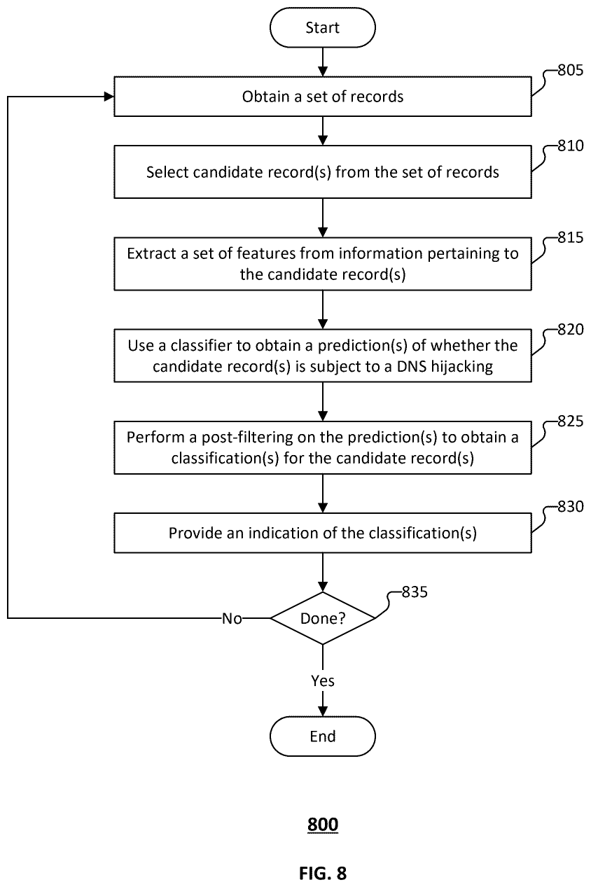

FIG. 8 is a flow diagram of a method for classifying a record according to various embodiments.

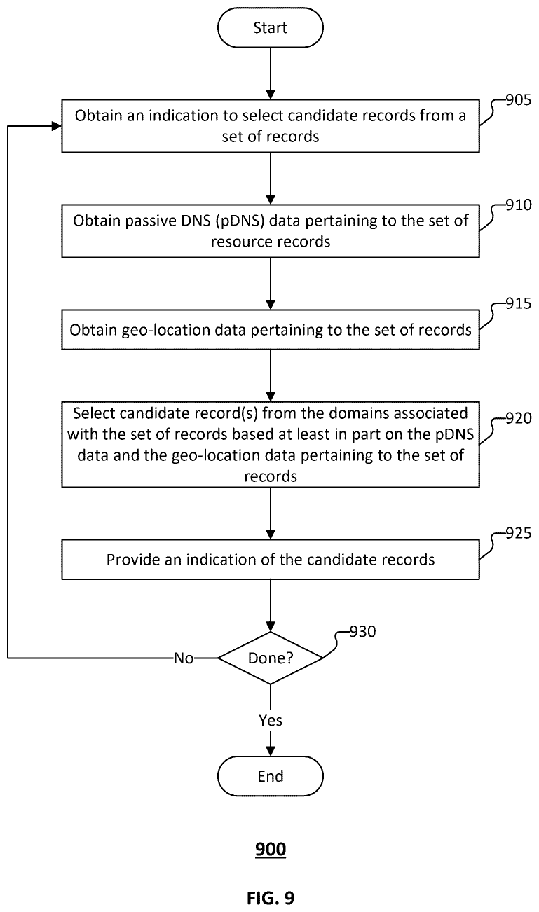

FIG. 9 is a flow diagram of a method for selecting candidate records according to various embodiments.

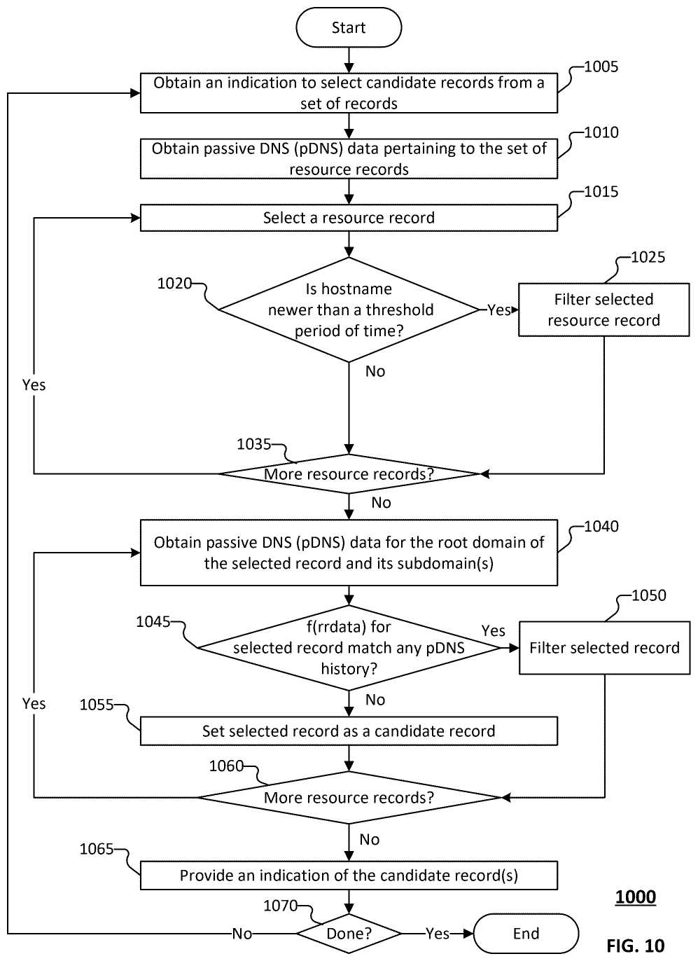

FIG. 10 is a flow diagram of a method for selecting candidate records according to various embodiments.

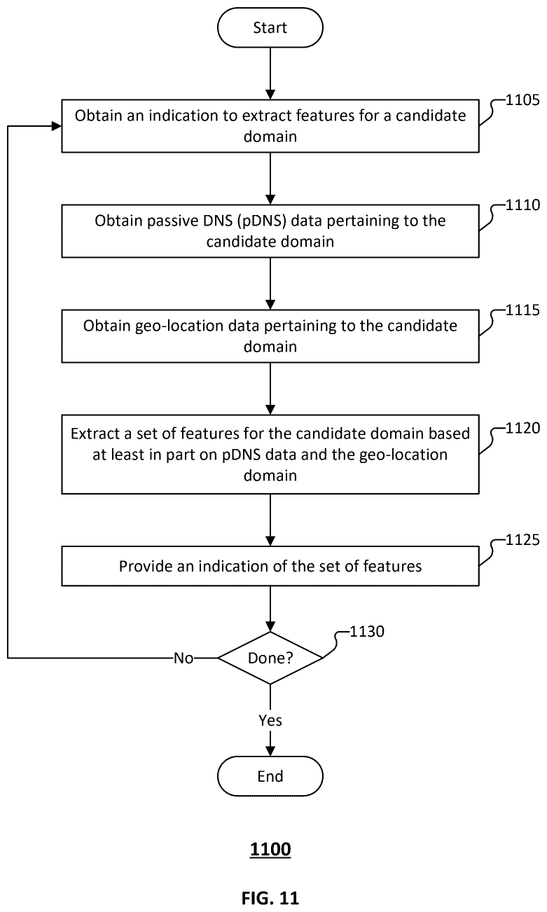

FIG. 11 is a flow diagram of a method for performing feature extraction for a candidate domain according to various embodiments.

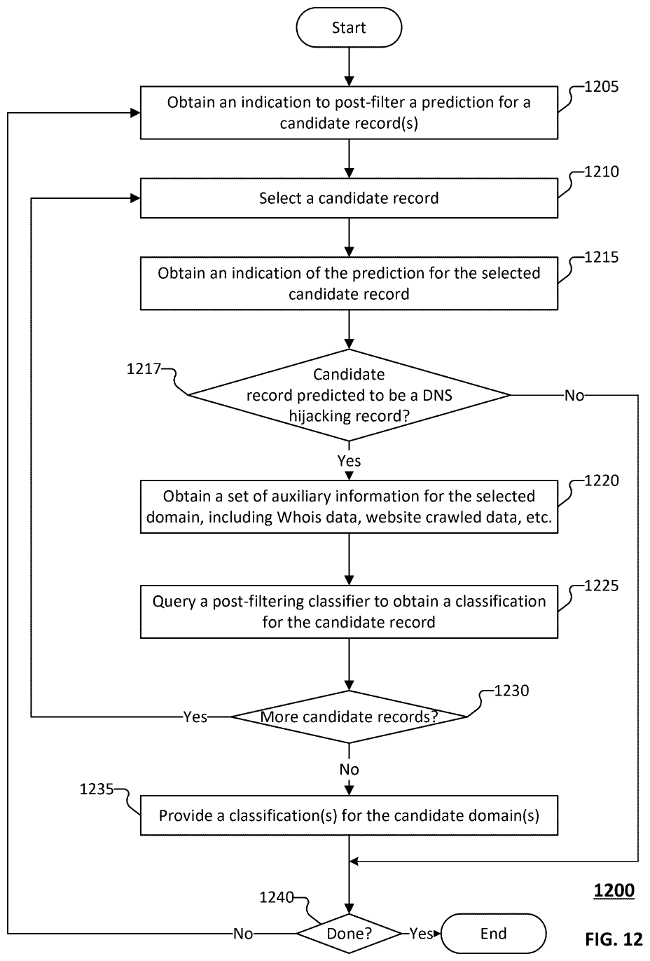

FIG. 12 is a flow diagram of a method for performing a post-filtering for classifying a candidate domain according to various embodiments.

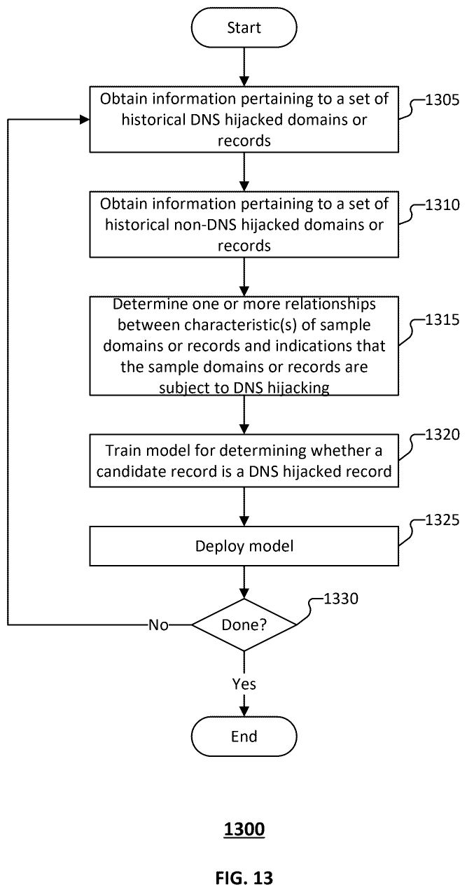

FIG. 13 is a flow diagram of a method for training a model according to various embodiments.

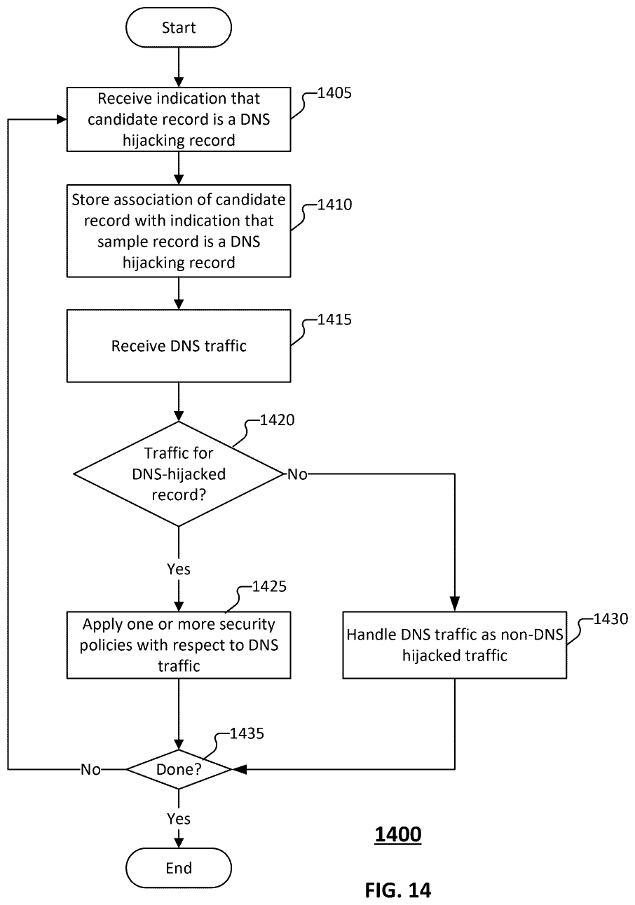

FIG. 14 is a flow diagram of a method for detecting malicious traffic according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In DNS hijacking attacks, malicious actors modify resource records (RRs) or add new resource records that belong to another entity without such other entity's permission. These changes (e.g., the modified or new RRs) are often very short lived because the owner of the domains will notice the change and recover the domains. However, even the short duration can cause considerable damages both to the reputation of the domain owner and the safety of their customers/users. Sometimes these attacks occur in an orchestrated manner (e.g., campaigns) as part of a larger attack. Therefore, uncovering these instances can help in detecting larger malicious behaviors, and if a system detects the occurrence of the attack in time, the can prevent significant damages.

Various embodiments provide a method and system configured to detect the attacks as soon as (or shortly after) the attacks occur. Additionally, various embodiments provide a method and system for identifying the attacks currently being perpetrated or that occurred in the recent past (e.g., 1 day). The method uses a set of features extracted from a variety of data sources to query a classifier for a classification of whether the record is a DNS hijacking record.

DNS hijacking refers to the occurrence of a malicious actor taking control of the DNS records of a victim domain and inserting new records or modifying old ones. Attackers hijack DNS records to attack visitors of the domain name by serving the visitors malicious content including man-in-the-middle (MitM) attacks, drive-by-download, phishing and scams. Alternatively, malicious actors can hijack domain names to use the domain reputation for malicious campaigns independent of the visitors to the victim domain. Malicious actors can use any of several techniques to hijack DNS records. An example technique is the malicious actor can take over the domain owner's account at a domain registrar or at a DNS service provider (or alternatively infiltrate the registrar/DNS service provider). The malicious actor can take over the account, for example, via phishing, password guessing, or a breach of another site. Another example technique is the malicious actor can hijack DNS records via DNS cache poisoning or other attacks targeting DNS.

Various embodiments provide security services to customers (e.g., domain owners, or users that access domains, such as via traffic across an enterprise network) by detecting hijacked DNS records. The system can detect the hijacked DNS records by leveraging passive DNS logs and auxiliary information. In some embodiments, the system tracks new DNS records and then extracts features about the new DNS records using passive DNS (pen's) data and geolocation data. The system uses these features to query a machine learning model that is trained to predict the likelihood of a record being hijacked (e.g., DNS hijacking) or not. Because hijacked records can sometimes exhibit similar behavior to normal records, in some embodiments, the system uses auxiliary information such as web crawls, WHOIS, and zone files information to perform a post filtering to decide if a record is truly hijacked.

Various embodiments provide a system, method, or device for detecting DNS hijacking records. The method includes (i) obtaining passive DNS (pDNS) data pertaining to a set of resource records, (ii) extracting a first set of features based at least in part on the pDNS data and geolocation data for a selected resource record, (iii) using a classifier to determine whether a candidate record corresponding to the selected resource record is a result of a DNS hijacking based at least in part on the first set of features, and (iv) performing an active measure in response to determining that the candidate record is the result of the DNS hijacking. The selected record is selected from the obtained set of resource records.

Various embodiments provide a system, method, or device for training a hijacked record classifier. The method includes (i) obtaining a set of training candidate record; (ii) obtaining a set of pDNS data for the set of training candidate record, the set of pDNS data comprising data for a set of organic DNS records and data for a set of simulated DNS hijacking records, (iii) performing a machine learning process to generate (e.g., train) a hijacked record classifier based at least in part on the set of pDNS data for the set of training candidate records; (iv) and deploying the hijacked record classifier in a system to perform detection of hijacked records.

In some embodiments, the classifier or model used in connection with generating a prediction of whether a record is subject to DNS hijacking is a machine learning model that is trained using a machine learning process. Examples of machine learning processes that can be implemented in connection with training the model(s) include random forest, support vector machine, naive Bayes, logistic regression, K-nearest neighbors, decision trees, etc. In some embodiments, the system trains a random forest machine learning record classification model.

In some embodiments, a detection pipeline to detect DNS hijacking is periodically executed to update domain classifications, which can be used in connection with performing an active measure and/or can be published to security entities or network nodes via domain allowlist or denylist.

According to various embodiments, the system uses passive DNS data (e.g., obtained by querying a pDNS dataset) to obtain the history of resource records (RRs), and passes this data (e.g., the pDNS data and/or the history data) to a feature extractor module/service to obtain a set of features. The feature extraction module obtains the history data and looks for changes observed in rrname-rrdata pairs. For example, feature extractor extracts a set of features by comparing the statistics of the past rrdata for the rrname-rrdata pairs in addition to the statistics of the new rrdata. In some implementations, the feature extractor extracts a set of 74 features (e.g., to be used in a model). The feature extraction module is also configured to extract a set of domain features such as the number of new IPs seen in the domain's A records (e.g., obtained from the pDNS data) in the recent past. Examples of the features extracted based at least in part on the pDNS data are provided in Tables 1 and 2 below. In response to performing feature extraction, the system passes the extracted features to a machine learning (ML) model that predicts the verdict (e.g., the ML model generates a prediction that corresponds to a likelihood that the record is a DNS hijacking record).

Optionally, the system implements a post-processing/post-filtering technique that filters the verdicts generated by the ML model to obtain classifications of whether the record is a DNS hijacking record. The classifications generated by performing the post-filtering technique increases the confidence in the verdicts, particularly by reducing the rate of potential false positive verdicts. In some implementations, the post-filtering technique comprises two steps. In the first step, the system performs a comparative analysis of the web contents hosted on the hijacked address and the original address. If the content is the same on both IP addresses, then the system concludes that the new record is not a hijacked record. Additionally, if the collected WHOIS data indicates that the domain is newly registered or that the ownership recently changed, then the system (e.g., the DNS hijacking record detection pipeline) will not consider the record as hijacked (e.g., the DNS record will not be deemed to have been a result of a DNS hijacking attack). In the second step, the system uses a length of time over which the rrdata for a new record persists to filter the verdicts. If the rrdata for a new record persists over a duration of time (e.g., more than a threshold period of time), the verdict is filtered out or the classification for the candidate record is changed to indicate that the candidate is benign. The system uses the length of time over which rrdata for a new record is persisted to filter the verdicts because of the generally short-lived nature of a DNS hijacking attack.

According to various embodiments, the system uses DNS hijacking record classifications to block DNS responses for such DNS hijacking records from reaching customers or the security service (e.g., customer enterprise networks, or client systems managed by or connected to the enterprise network). Additionally, or alternatively, the system uses DNS hijacking record classifications to block DNS requests about the domain for which the system identified a DNS hijacking record. One reason to block a DNS response if it comprises a resource record resulting from DNS hijacking is that the system (e.g., a security system) can enable customers to access the domain if the DNS response they receive is benign and is not the result of DNS hijacking.

According to various embodiments, the system looks at all DNS new resource records (or “records”) observed in a timeframe (e.g. one day, one week, or some other predefined period). From these collected observed records using candidate selection and leveraging pDNS, the system selects candidate DNS hijacking records (or “candidate records”). The system extracts features about these candidate records using at least pDNS (e.g., the system can collect data about the root portion of rrname and the rrdata) and geolocation, and classify (e.g., using a classifier such as a machine learning model) the candidate records as DNS hijacking records or not DNS hijacking records. In some embodiments, the system collects additional information about DNS hijacking records to filter potential false positives.

A major challenge for training a machine learning model is to have access to a large and good set of labeled samples. Unfortunately, such datasets do not exist for DNS hijacking attacks. For example, a manual investigation of passive DNS data uncovered fewer than 100 samples, which is not enough to train and test a classifier. To solve this issue, various embodiments implement a technique to generate simulated DNS hijacking attack campaigns. In some embodiments, the system generates simulated DNS hijacking records. The technique for generating simulated DNS hijacking attack campaigns may have parameters that can be adjusted to generate hijacking campaigns with different levels of detection difficulties. The synthetic hijacking records (e.g., the simulated DNS hijacking records) are then inserted into a pDNS dataset to create datasets that very closely resemble real-world hijacking scenarios. This data (e.g., the pDNS dataset comprising a subset of organic DNS records and a subset of synthetic DNS records) is utilized to train and evaluate the machine learning model that is used to detect DNS hijacking attacks.

FIG. 1 is a block diagram of an environment in which a malicious domain is detected or suspected according to various embodiments. In various embodiments, system 100 is implemented in connection with system 200 of FIG. 2, system 300 of FIG. 3, service 400 of FIG. 4, system 500 of FIG. 5, system 600 of FIG. 6, or one or more of processes 700-1400 of FIGS. 7-14.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains, DNS responses comprising DNS hijacking records, or stockpiled domains, or such as traffic for certain applications (e.g., SaaS applications). In some embodiments, data appliance 102 is also configured to enforce policies with respect to traffic that stays within (or from coming into) enterprise network 110.

Techniques described herein can be used in conjunction with a variety of platforms (e.g., desktops, mobile devices, gaming platforms, embedded systems, etc.) and/or a variety of types of applications (e.g., Android.apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including classifying domains (e.g., predicting whether a domain is a malicious domain, etc.), classifying DNS response records (e.g., predicting whether a domain IP pair in a DNS response is a DNS hijacking record, etc.), classifying network traffic, providing a mapping of signatures to certain domains or DNS records (e.g., a DNS record for which a predicted likelihood that the record is a DNS hijacking record exceeds a predefined likelihood threshold, etc. a mapping of domains or DNS records to domain or DNS record data (e.g., domain certificates, pDNS data, active DNS data, WHOIS data, etc.), performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacking record, providing a list of signatures of known exploits (e.g., malicious input strings, malicious files, malicious domains, etc.) to data appliances, such as data appliance 102 as part of a subscription, detecting exploits such as malicious input strings, malicious files, DNS hijacking records or malicious domains (e.g., an on-demand detection, or periodical-based updates to a mapping of domains or DNS records to indications of whether the domains or DNS records are malicious or benign), providing a likelihood that a record is a DNS hijacking record (e.g., a DNS hijacking record) or benign (e.g., not DNS hijacking), providing/updating an allowlist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign). In some embodiments, services provided by security platform 140 additionally comprise simulating DNS hijacking attacks/campaigns (e.g., generating synthetic DNS hijacking records), and/or training classifiers (e.g., training machine learning models, such as to be used to provide detection of DNS hijacking records).

In some embodiments, security platform 140 classifies the domains in response to receiving a network traffic sample or according to a predefined schedule. In connection with detecting DNS hijacking records, security platform 140 can obtain information pertaining to the domains (e.g., pDNS data, geolocation data, etc.) and classify the DNS records (e.g., the corresponding domains) based at least in part on querying a machine learning model. Security platform 140 may perform periodic polling or monitoring of pDNS data and geolocation data, such as in connection with training a classifier, and/or classifying a set of domains or DNS records. Security platform 140 may process the collected records and corresponding data pertaining to the domains (e.g., the pDNS data, the geolocation data, etc.) in batches such as according to a predefined frequency (e.g., daily, weekly, etc.). The periodic polling or monitoring may be performed according to a predefined schedule or a predefined frequency or time period (e.g., daily, weekly, monthly, etc.). Additionally, or alternatively, security platform 140 determines (e.g., predicts) a domain or DNS record classification in response to receiving a DNS request or DNS response from an endpoint or network entity, such as a data appliance or other firewall or security entity. For example, security platform 140 can perform the domain classification on a DNS response basis as the endpoint or network entity detects traffic for a new domain or DNS record, or suspicious traffic to/from a domain or traffic comprising a DNS record.

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

In some embodiments, DNS record classifier 170 detects/classifies a record. For example, DNS record classifier 170 predicts whether a particular DNS record (e.g., a candidate record) is a DNS hijacking record (e.g., whether the candidate record is a DNS hijacking record). In some embodiments, DNS record classifier 170 additionally predicts whether a particular domain is a malicious domain or a DNS hijacked domain. In some embodiments, DNS record classifier 170 classifies the domain or DNS record based at least in part on a signature of the candidate domain or DNS record, such as by querying a mapping of signatures to domain or DNS record identifiers (e.g., a set of previously analyzed/classified domains or DNS records). As an example, DNS record classifier 170 uses a signature or domain or DNS record identifier to query a denylist of domains or records to check whether the candidate domain or DNS record is on the denylist of domains or records. In some embodiments, DNS record classifier 170 classifies the domain or DNS record based on a predicted domain or DNS record classification (e.g., a prediction of whether a candidate DNS record is a DNS hijacking record, whether the candidate record is not a DS hijacked record, or whether a candidate domain is malicious or benign, etc.). For example, DNS record classifier 170 determines (e.g., predicts) the domain or DNS record classification based at least in part on domain or DNS record data for the candidate domain or DNS record. Examples of domain or DNS record data include a certificate information pertaining to a certificate(s) associated with the candidate domain (e.g., the domain associated with the particular DNS request), registration information, pDNS data, geolocation data, scan data, active DNS information, zone file information, WHOIS registry data, web crawled data (e.g., data obtained by crawling the website), etc.

In some embodiments, DNS record classifier 170 determines a domain or DNS record classification for a candidate domain or DNS record based at least in part on a machine learning-based classification. As an example, DNS record classifier 170 uses a machine learning-based classifier to determine a prediction of whether the candidate DNS record is a DNS hijacking record. Additionally, DNS record classifier 170 may implement one or more of a fingerprinting-based classification, a heuristics-based classification, or other rule-based classification to classify the candidate domain or DNS record. For example, DNS record classifier 170 performs a post-filtering with respect to the predictions generated by the machine learning-based classifier. The post-filtering can be performed using a fingerprinting-based classifier, a heuristics-based classifier, and/or other rule-based classifier to filter out potential false positives generated by the machine learning-based classifier (e.g., to remove predicted candidate DNS records that are likely not DNS hijacking records).

In some embodiments, DNS record classifier 170 includes a model (e.g., ML model 176) that is trained to detect DNS hijacked domains or DNS hijacking records. In some embodiments, DNS record classifier 170 is trained to detect malicious records. In response to determining a predicted classification for a domain or DNS records (e.g., a candidate domain or DNS record), DNS record classifier 170 may determine a signature for the domain or DNS record and store the signature in a mapping of signatures to domains or DNS record classifications (e.g., an indication of whether the candidate domain or DNS record is malicious/DNS hijacking or benign/non-malicious/non-DNS hijacking) the domain or DNS record signature in association with the predicted classification.

In some embodiments, system 100 (e.g., DNS record classifier 170, security platform 140, etc.) trains a classifier (e.g., a model, such as ML model 176) to detect (e.g., predict) maliciousness of domains. For example, system 100 trains a classifier to perform domain or DNS record classification (e.g., to classify domains as malicious or benign/non-malicious). As another example, system 100 trains a classifier to determine whether a candidate DNS record corresponds to a DNS hijacking record. As another example, system 100 trains a classifier to determine whether a candidate domain corresponds to a DNS hijacked domain. The classifier is trained based at least in part on a machine learning process. Examples of machine learning processes that can be implemented in connection with training the classifier(s) include random forest, support vector machine, naive Bayes, logistic regression, K-nearest neighbors (KNN), decision trees, gradient boosted decision trees, a neural network (NN), etc. In some embodiments, DNS record classifier 170 implements a random forest model.

System 100 (e.g., DNS record classifier 170, security platform 140, etc.) performs feature extraction with respect to the candidate record from domain or DNS record data (e.g., pDNS data, geolocation data, certificates, registrant information, scan data, etc.). In some embodiments, system 100 (e.g., DNS record classifier 170) generates a set of features for training a machine learning model for classifying the DNS record (e.g., classifying whether the record is a DNS hijacking record/non-DNS hijacking record, or malicious/non-malicious). System 100 then uses the set of features to train a machine learning model (e.g., a random forest model) such as based on training data that includes non-hijacked samples of domains or DNS records and hijacked samples of domains or DNS records.

In some embodiments, system 100 (e.g., DNS record classifier 170, security platform 140, etc.) simulates DNS hijacking attacks/campaigns. For example, system 100 generates simulated DNS hijacking attacks/campaigns (e.g., synthetic records from organic and/or synthetic data) to increase the number of training samples with which the machine learning model can be trained.

According to various embodiments, security platform 140 comprises DNS tunneling detector 138 and/or DNS record classifier 170. Security platform 140 may include various other services/modules, such as a malicious file detector, a malicious traffic detector, a parked domain detector, a DNS hijacking record or DNS record detector, an application classifier or other traffic classifier, etc. DNS record classifier 170 is used in connection with analyzing samples of records and/or automatically detecting DNS hijacking record. For example, DNS record classifier 170 analyzes a candidate record and predicts whether the corresponding domain or DNS record is malicious or otherwise corresponds to a DNS hijacking record (e.g., that the domain has been subject to a DNS hijacking attack). In response to receiving an indication that an assessment of a candidate record (e.g., a domain or DNS record classification, determine whether the candidate domain or DNS record is DNS hijacking/non-DNS hijacking, etc.) is to be performed, DNS record classifier 170 analyzes the candidate record and obtains domain or DNS record data (e.g., pDNS data, geolocation data, etc.) for the candidate record to determine the assessment of the candidate record.

In some embodiments, in connection with determining the machine learning-based prediction classification, DNS record classifier 170 (i) receives an indication of a candidate record or otherwise performs a candidate record selection, (ii) obtains information pertaining the candidate record (e.g., domain or DNS record data such as pDNS data, geolocation data, etc.), (iii) determines a feature vector for the candidate domain based on the information pertaining to the candidate record, (iv) queries a model (e.g., a machine learning model), and (v) determines a DNS record classification, or otherwise whether the record is a DNS hijacking record (e.g., that the corresponding domain has been subject to a DNS hijacking attack) based on the querying the model (e.g., DNS record classifier 170 obtains a predicted classification).

In some embodiments, DNS record classifier 170 comprises one or more of DNS record data collection module 172, prediction engine 174 (e.g., a DNS-hijacking record detector), ML model 176, and/or traffic handling policy 178.

DNS record data collection module 172 is used in connection with obtaining samples (e.g., records or domains) such as based on network traffic or a predefined list. DNS record data collection module 172 obtains information pertaining to a DNS record or domain, such as in connection with identifying certain elements of DNS record or domain data for the DNS record. DNS record data collection module 172 may query a dataset or third-party service(s) for domain data or DNS record data. For example, DNS record data collection module 172 may query a WHOIS database for registrant information, passive DNS (pDNS) datasets or logs, active DNS datasets or logs, geolocation datasets or services, certificate logs (e.g., to obtain certificates for the particular domain), etc. DNS record data collection module 172 extracts information from the domain data, the corresponding DNS record data, or the domain name itself.

Prediction engine 174 (e.g., a DNS hijacking record detector) is used in connection with predicting a classification for the domain (e.g., the candidate domain), detecting a DNS hijacking record, or otherwise predicting whether the corresponding domain is DNS hijacking/non-DNS hijacking, or malicious/non-malicious. Similarly, prediction engine 174 (e.g., a DNS hijacking record detector) is used in connection with predicting a classification for a DNS record (e.g., the candidate record corresponding to a particular domain, or DNS response), detecting a DNS hijacking record, or otherwise predicting whether the corresponding record is DNS hijacking/non-DNS hijacking.

In some embodiments, prediction engine 174 performs a machine learning-based classification, for example, by querying ML model 176. DNS record classifier 170 (e.g., prediction engine 174) may be further configured to post-filter the predictions generated by the machine learning model (e.g., the machine learning-based classifications), such as to reduce the number of false positives. The post-filtering can implement a fingerprinting-based classification/filtering, a heuristic-based classification/filtering, or another rule-based classification filtering, or a machine learning-based filtering.

In some embodiments, the classifier (e.g., ML model 176) is trained using a machine learning process. For example, the classifier is a random forest model. The random forest model may be trained from a training set comprising a subset of benign records or domains (e.g., records for known or previously classified benign domains) and a subset of DNS hijacking records or domains (e.g., records known or previously classified DNS hijacking records).

In some embodiments, prediction engine 174 receives, from the machine learning model (e.g., ML model 176), an indication of a likelihood that the candidate record corresponds to a DNS hijacking record, a likelihood that the candidate record is not a DNS hijacking record, a likelihood that the candidate domain is a malicious domain, or a likelihood that the candidate domain is benign/non-malicious domain, etc., In response to receiving the indication of the likelihood that the candidate record corresponds to a DNS hijacking record, a likelihood that the candidate record is not a DNS hijacking record, prediction engine 174 determines (e.g., predicts) a record classification based on such likelihood. For example, prediction engine 174 compares the likelihood that the candidate record corresponds to a DNS hijacking record to a likelihood threshold value. In response to a determination that the likelihood that the candidate record corresponds to a DNS hijacking record is greater than the likelihood threshold value, prediction engine 174 may deem (e.g., determine that) the candidate record to correspond to a DNS hijacking record.

According to various embodiments, in response to prediction engine 174 classifying the candidate record, system 100 handles the DNS response corresponding to the record according to a predefined policy (e.g., a security policy). For example, in response to predicting that the candidate record is a DNS hijacking records, system 100 can cause the DNS response to be blocked, etc.

According to various embodiments, in response to prediction engine 174 classifying the candidate record, system 100 handles the traffic to/from the candidate domain according to a predefined policy (e.g., a security policy). For example, the system queries traffic handling policy 178 to determine the manner by which traffic to/from a domain matching the candidate domain is to be handled. Traffic handling policy 178 may be a predefined policy, such as a security policy, etc. Traffic handling policy 178 may indicate that traffic to/from certain domains is to be blocked and traffic to/from other domains is to be permitted to pass through the system (e.g., routed normally). Traffic handling policy 178 may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed candidate record, security platform 140 (e.g., DNS record classifier 170) sends an indication that records matching the candidate record are associated with, or otherwise correspond to, the determined classification. In some embodiments, in the case that the determined classification for the candidate record is that the candidate record is a DNS hijacking record, security platform 140 can optionally provide an indication that traffic to/from a domain matching the domain in the DNS hijacking record (e.g., the same domain signature or same originating IP address, etc.). Security platform 140 can provide an indication that DNS responses corresponding to a predicted DNS hijacking record to be handled as a DNS hijacking record. For example, security platform 140 determines (e.g., computes) a signature or identifier for the domain or DNS record for the candidate record (e.g., a hash or other signature), and sends to a network node (e.g., a security entity, an endpoint such as a client device, etc.) an indication of the classification associated with the signature (e.g., an indication whether the record is a DNS hijacking record, or an indication of whether the domain is a malicious/non-malicious domain, or an indication of whether traffic to/from the domain is malicious traffic). Security platform 140 may update a mapping of signatures to domain or DNS record classifications and provide the updated mapping to the security entity. In some embodiments, security platform 140 further provides to the network node (e.g., security entity, client device, etc.) an indication of a manner by which traffic to a domain or DNS responses comprising a DNS record matching the signature is to be handled. For example, security platform 140 provides to the security entity a traffic handling policy, a security policy, or an update to a policy.

In some embodiments, system 100 (e.g., prediction engine 174 of network traffic classifier, or other security entity, etc.) determines whether information pertaining to a particular candidate record (e.g., a newly received candidate record to be analyzed) is comprised in a dataset of historical domains and records (e.g., historical network traffic, previously classified domains or records), whether a particular signature is associated with malicious traffic, or whether traffic corresponding to the candidate record to be otherwise handled in a manner different than the normal traffic handling. The historical information may be provided by another system or module, such as a service running on security platform 140, or by a third-party service such as VirusTotal™, or both. In response to determining that information pertaining to a candidate record (or corresponding domain) is not comprised in, or available in, the dataset of historical domains and records (e.g., historical or previously analyzed domains or records), system 100 (e.g., DNS record classifier 170 or other security entity) may deem that the domain/record/traffic has not yet been analyzed and system 100 can invoke an analysis (e.g., a DNS record analysis) of the candidate record (e.g., an analysis of the domain or DNS record data for the candidate record) in connection with determining (e.g., predicting) the record (e.g., DNS record) classification. The historical information (e.g., from a third-party service, a community-based score, etc.) indicates whether other vendors or cyber security organizations deem the particular traffic as malicious or should be handled in a certain manner.

DNS hijacked domains, for example, can be used for MitM attacks, scams, phishing sites, or sites used to distribute C2 exploits or malware.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is a block diagram of a system to detect a malicious record according to various embodiments. According to various embodiments, system 200 is implemented in connection with system 100 of FIG. 1, such as for DNS record classifier 170. In various embodiments, system 200 is implemented in connection with system 300 of FIG. 3, service 400 of FIG. 4, system 500 of FIG. 5, system 600 of FIG. 6, or one or more of processes 700-1400 of FIGS. 7-14. System 200 may be implemented in one or more servers, a security entity such as a firewall, and/or an endpoint.

System 200 can be implemented by one or more devices such as servers. System 200 can be implemented at various locations on a network. In some embodiments, system 200 implements DNS record classifier 170 of system 100 of FIG. 1. As an example, system 200 is deployed as a service, such as a web service (e.g., system 200 determines whether traffic corresponds to a particular domain, and provides such determinations as a service). The service may be provided by one or more servers. For example, system 200 or network traffic classifier is deployed on a remote server that monitors or receives network traffic that is transmitted within or into/out of a network and determines the traffic classification (e.g., whether the traffic is malicious traffic, such as traffic to/from a domain classified as a DNS hijacked domain whether a DNS response comprises a DNS record classified as a DNS hijacking record, whether the traffic is non-malicious, such as traffic to/from a domain that is not classified as a DNS hijacked domain or whether a DNS response comprises a DNS record classified as not being a DNS hijacking record, etc.) and sends/pushes out notifications or updates pertaining to the network traffic such as (a) an indication of the domain to which the network traffic corresponds or an indication of whether a domain is DNS hijacked or otherwise malicious, or (b) an indication that a DNS response corresponds to a record that is classified as (e.g., predicted to be) a DNS hijacking record. As another example, the network traffic classifier is deployed on a firewall. In some embodiments, part of system 200 is implemented as a service (e.g., a cloud service provided by one or more remote servers) and another part of system 200 is implemented at a security entity or other network node such as a client device.

In some embodiments, system 200 is deployed on one or more servers and is configured to identify new records and in response to detecting a new record, classifying the domain (e.g., classifying the domain as DNS hijacked or non-DNS hijacked, etc.). For example, system 200 is configured to classify domains at a predefined frequency, such as to periodically monitor a set of domains to determine whether the domains have been DNS hijacked. In response to detecting the DNS hijacked domain, system 200 may implement an active measure, such as providing to another system (e.g., a firewall, an endpoint, an edge device, etc.) an indication that the domain corresponds to a malicious domain.

In some embodiments, system 200 is deployed on one or more servers and is configured to identify new DNS records (e.g., records corresponding to an intercepted DNS response) and in response to detecting a new record, classifying the record (e.g., classifying the record as DNS hijacking or non-DNS hijacking, etc.). For example, system 200 is configured to classify DNS records at a predefined frequency, such as to periodically monitor a set of DNS records to determine whether the DNS records are a result of a DNS hijacking attack. In response to detecting a DNS hijacking record, system 200 may implement an active measure, such as providing to another system (e.g., a firewall, an endpoint, an edge device, etc.) an indication that the DNS record corresponds to a hijacked domain, or to provide an indication to block DNS responses for such DNS record.

In some embodiments, system 200 receives network traffic and predicts a traffic classification (e.g., whether the traffic is malicious traffic or non-malicious traffic, such as based on a prediction of whether the traffic is to/from a domain associated with a DNS hijacking record, or a prediction of whether the traffic comprises a DNS response for a DNS record classified as a DNS hijacking record, etc.). System 200 can perform an active measure (or cause an active measure to be performed) in response to determining the traffic classification. For example, system 200 performs an active measure in response to determining that the traffic is a DNS response comprising a DNS record classified as (e.g., deemed to be) a DNS hijacking record. As another example, system 200 handles the traffic according to normal/benign traffic in response to determining that the traffic is a DNS response comprising a DNS record that is not classified as being a DNS hijacking record.

In the example shown, system 200 implements one or more modules in connection with predicting a record classification, determining a likelihood that a record is a DNS hijacking record, etc. System 200 comprises communication interface 205, one or more processors 210, storage 215, and/or memory 220. One or more processors 210 comprises one or more of communication module 225, record request module 227, signature generation module 229, domain data obtaining module 231, pre-filtering module 233, candidate record selection module 235, feature extraction module 237, model training module 239, post-filtering module 241, classification module 243, notification module 245, and security enforcement module 247.

In some embodiments, system 200 comprises communication module 225. System 200 uses communication module 225 to communicate with various nodes or end points (e.g., client terminals, firewalls, DNS resolvers, data appliances, other security entities, etc.), user systems such as an administrator system, and/or third-party services (e.g., a certificate authority service, a network/internet crawler or scanner, a pDNS service, a geolocation service, and/or a registrar service provider, such as a WHOIS service, etc.). For example, communication module 225 provides to communication interface 205 information that is to be communicated (e.g., to another node, security entity, etc.). As another example, communication interface 205 provides to communication module 225 information received by system 200. Communication module 225 is configured to receive an indication of domains (e.g., candidate domains, network traffic, records for collected domains, etc.) to be analyzed, such as from network endpoints or nodes (e.g., that intercept or otherwise collect observed DNS requests or DNS responses, etc.) such as security entities (e.g., firewalls), database systems, query systems, etc., or based on a periodic (e.g., according to a predefined frequency, etc.) polling of a service for an indication of newly registered domains, newly seen records (e.g., newly created/updated DNS records). Communication module 225 is configured to query third party service(s) for information pertaining to the domain or records (e.g., services that expose information/classifications for signatures/hashes of domains, registrants of domains, etc., such as third-party scores or assessments of maliciousness of a particular domain or a domain registrant, a community-based score, assessment, or reputation pertaining to domains or applications, a denylist for domains, and/or an allowlist for domains, applications, or other certain types of network traffic, etc.). For example, system 200 uses communication module 225 to query the third-party service(s) to obtain pDNS data, geolocation data, or auxiliary data (e.g., WHOIS data or web crawled data). Communication module 225 is further configured to receive one or more settings or configurations from an administrator. Examples of the one or more settings or configurations include configurations of a process determining whether a particular type of traffic (e.g., a particular HTTP request) is permitted, malicious, benign, etc., a format or process according to which a feature vector or embedding is to be determined, a set of feature vectors or embeddings to be provided to a classifier for determining the domain or DNS record classification (e.g., for predicting whether a record is DNS hijacking/non-DNS hijacking), a set of predefined signatures to be assessed or counted, information pertaining to an allowlist of domains, applications, nodes, or signatures for traffic (e.g., traffic that is not deemed suspicious or malicious), information pertaining to a denylist of domains, applications, nodes, or signatures for traffic (e.g., traffic that is deemed to be suspicious or malicious and for which traffic is to be quarantined, deleted, or otherwise to be restricted from being executed/transmitted), etc.

In some embodiments, system 200 comprises record request module 227. System 200 uses record request module 227 to receive a request to classify a record. System 200 may determine to record classification (e.g., determine/predict whether the record is a DNS hijacking record or a non-DNS hijacking record) based at least in part on a request to predict whether record is a DNS hijacking record. In some embodiments, the request to classify a record is obtained in connection with a periodic analysis of records (e.g., DNS records), such as a predefined set of monitored domains or other list of domains. For example, system 200 (or another service) determines to classify set of domains or DNS records according to a predefined time period/frequency. For example, system 200 determines a set of DNS records observed during a particular period of time (e.g., within the last 24 hours) and classifies the records (or at least a subset of the records, such as based on a candidate record selection process).

In some embodiments, system 200 comprises signature generation module 229. System 200 uses signature generation module 229 to obtain an identifier associated with the domain and/or record (e.g., DNS record). The identifier may be the domain name, the rrdata (e.g., an IP address), and/or a signature generated based on the domain name and the rrdata (e.g., the IP address). For example, signature generation module 229 performs a hash on the domain name or the rrdata (e.g., the IP address) to obtain a signature corresponding to the domain and/or record. In some embodiments, the signature comprises rrname, rrdata, and rrtype. For example, the signature may be a triplet based on (rrname, rrdata, and rrtype) for the corresponding DNS record. System 200 may use the identifier (e.g., the signature) in connection with querying a mapping of domains or records (or identifiers/signatures associated with the domains or records) to indications of whether the domains are DNS hijacked or indications of whether the DNS records are predicted to be results of a DNS hijacking attack. For example, the mapping of domains to indications of whether the domains are hijacked or otherwise malicious (e.g., a denylist for malicious domains) may be used to quickly determine whether the domain has been previously analyzed and determined to be hijacked or otherwise malicious. In response to determining that the domain is not included in the mapping, system 200 predicts a classification for the domain (e.g., the domain associated with the record request received by record request module 227). For example, the system determines the domain classification or DNS record classification based on performing a machine learning (ML)-based prediction. The system may be additionally configured to post-filter the ML-based prediction to obtain the classification.

In some embodiments, system 200 comprises data obtaining module 231. System 200 uses data obtaining module 231 to obtain domain data or DNS record data. As an example, system 200 obtains the domain data in response to querying mapping of domains (or domain identifiers/signatures) to indications of whether the domains are DNS hijacked or otherwise malicious, and determining that the mapping does not comprise the domain. As another example, system 200 obtains the DNS record data in response to querying a mapping of records to indications of whether the records are deemed DNS hijacking records, and determining that the mapping does not comprise the particular record. In some embodiments, data obtaining module 231 obtains the domain data or DNS record data from one or more datasets (e.g., local storage, a remote database) and/or one or more third party services. Examples of domain data or DNS record data include certificate information pertaining to a certificate(s) associated with the candidate domain (e.g., the domain associated with the particular domain request), registration information, pDNS data, geolocation data, scan data, active DNS information, zone file information, WHOIS data, web crawled data, etc.

Registration information comprises information pertaining to the domain registration, including an indication of the individual or entity that registered the domain name. For example, the registration information comprises registrant data obtained from the WHOIS database/service, etc. Data obtaining module 231 may query an internal service or a third-party service (e.g., the WHOIS database/service) for registration information associated with the candidate domain.

pDNS data includes information from pDNS logs pertaining to a DNS query and response logs from different vantage points. In some embodiments, pDNS data includes historical data, such as the entire history of pDNS records for the particular domain, or historical information over a predefined period of time. Data obtaining module 231 may query the pDNS logs to obtain pDNS information for a candidate record's domain and rrdata (e.g., IP address).

Active DNS information includes information pertaining to the domain, such as an indication of the records configured for the candidate domain. Data obtaining module 231 obtains the active DNS information from actively querying domain names for records that may be configured for the candidate domain including A, AAAA, NS, MX, CNAME records).

Zone file information may include zone files for a top-level domain. Some top-level domains make their zone files public for researchers. Data obtaining module 231 may obtain data from the zone files. Additionally, or alternatively, data obtaining module 231 obtains a zone file for a top level domain (TLD). The zone file comprises a list of domains and their NS records under that zone (e.g., all.com domains, etc.).

In some embodiments, system 200 comprises pre-filtering module 233. System 200 uses pre-filtering module 233 to filter a set of records or domains for which system 200 has been requested to evaluate/classify. Pre-filtering module 233 removes records that are not going to be used to generate classifications. For example, pre-filtering module 233 removes one or more of: (a) resource records that have invalid fields (e.g., domains comprising invalid characters, IP addresses that have invalid values, etc.), (b) resource records with values that only work on local internal networks (e.g., internal domains and private or reserved IP address ranges), (c) types of records for which the system is not configured to perform hijacking detection. Various other types of records/domains can be pre-filtered. For example, the rules for pre-filtering records may be configured by an administrator, etc.

In some embodiments, system 200 comprises candidate record selection module 235. System 200 uses candidate record selection module 235 to determine, from the set of records for which system 200 is requested (or otherwise determines) to evaluate/classify, a set of candidate records to be evaluated (e.g., for which system 200 is to generate predictions using an ML model). In some embodiments, candidate selection module 235 implements service 400 of FIG. 4 to perform the candidate selection. In the example shown, candidate selection module 235 obtains pDNS data and geolocation data and uses such data in connection with performing the candidate selection. Candidate selection module 235 can obtain the pDNS data from pDNS dataset 370 (e.g., a third party service, or a dataset stored in a database), and geolocation data from a geolocation dataset 380 (e.g., a third party service, or a dataset stored in a database).

In some embodiments, system 200 comprises feature extraction module 237. System 200 uses feature extraction module 237 to extract a set of features for the records. The set of features can be extracted based at least in part on one or more of pDNS data and geolocation data, etc.

According to various embodiments, feature extraction module 237 extracts four types or groups of features. For example, the system extracts the four types/groups of features from the information pertaining to the candidate records. Three groups of features pertain to the statistics of the historical and new IP addresses and one group of features pertains to the features of the records.

In some embodiments, system 200 comprises model training module 239. System 200 uses model training module 239 to train the machine learning model used to perform DNS record classification (e.g., to predict whether a candidate record corresponds to a DNS hijacking record).

In some embodiments, system 200 comprises post-filtering module 241. System 200 uses post-filtering module 241 to filter predicted domain classifications or predicted record classifications. The post filtering of domain classifications or record classifications may be optional. Because the classifier does not have perfect accuracy at least in part because the data the classifier encounters (e.g., the domain data) after deployment (e.g., in production) can have a significantly different distribution compared to the training data (e.g., the labeled data used to train the classifier), post-filtering is performed to remove potential false positives (e.g., false classifications that a particular record is a DNS hijacking record).

In some embodiments, post-filtering module 241 obtains auxiliary data. Examples of auxiliary data that can be used to post-filter the ML-based classifications include WHOIS data, web crawled data, etc. Post-filtering module 241 uses such data to specifically identify domains that exhibit patterns that are not consistent with DNS hijacked domains or consistent with being associated with a DNS hijacking record, or for which a domain classification or record classification is expected to result in a false positive that can significantly impact devices (e.g., devices of customers of the DNS hijacking record detection service). For example, system 200 may decide that newly registered domains are likely to be false positive DNS hijacking classifications.

Post-filtering module 241 is configured to classify the record based at least in part on the auxiliary information. For example, post-filtering module 241 is configured to make a final decision of whether we believe the record is deemed to be the result of a DNS hijacking attack based at least in part on the auxiliary information. In response to determining that a record is classified a DNS hijacking record, system 200 (e.g., post-filtering module) sends the record to a datastore to be blocked for customers (e.g., to block DNS responses for such records). For example, system 200 updates a denylist of records based on the classification of the record as a DNS hijacking record.

In some embodiments, post-filtering module 360 implements a classifier. The classifier can be a rule-based classifier, a heuristics-based classifier, a machine learning-based classifier, or any combination thereof.

In some embodiments, system 200 comprises classification module 243. In some embodiments, system 200 uses classification module 243 to determine a record classification, such as to predict whether the candidate record corresponds to a DNS hijacking record and/or predict whether the candidate record is not a DNS hijacking record, etc. In some embodiments, system 200 uses classification module 243 to determine a domain classification, such as to predict whether the candidate domain corresponds to a DNS hijacked domain and/or a malicious domain, predict whether the candidate domain is a benign domain, etc. Classification module 243 determines the record classification (e.g., determines a prediction likelihood of whether the candidate record is a DNS hijacking record) based on querying a classifier, such as a machine learning model. In some embodiments, the classifier is a Random Forest model. Various other models according to other machine learning techniques may be implemented.

In some embodiments, classification module 243 provides a scalable ML-based prediction technique to detect DNS hijacking records. The classifier implemented by classification module 243 is trained based on a set of features extracted from domain data, such as registration information, geographic data, pDNS data, scan data, active DNS information, zone file information, etc.

Classification module 243 may query the classifier and obtain an indication of a likelihood that the candidate record corresponds to a DNS hijacking record. Classification module 243 may determine that the candidate record corresponds to a DNS hijacking record in response to determining the likelihood that the record corresponds to a DNS hijacking record obtained based on querying the classifier exceeds a predefined DNS hijacking record likelihood threshold.

According to various embodiments, classification module 243 implements a classifier (e.g., a machine learning model) to classify the candidate record based on collected domain data and/or record data for the candidate record or corresponding domain. System 200 may train the classifier, or system 200 may obtain the classifier from a service. The classifier is trained based at least in part on a machine learning process. Examples of machine learning algorithms that can be implemented in connection with training the classifier(s) include random forest, support vector machine, naive Bayes, logistic regression, K-nearest neighbors (KNN), decision trees, gradient boosted decision trees, a neural network (NN), etc. The classifier provides a predicted classification (e.g., a machine learning-based predicted classification), such as a prediction of whether a candidate record is a DNS hijacking record.

In some embodiments, system 200 comprises notification module 245. System 200 uses notification module 245 to provide an indication of the domain classification, such as an indication whether the candidate record is a DNS hijacking record, etc. Notification module 245 provides the indication (e.g., the report) to another system or service, such as security entity requesting the record classification or otherwise handling traffic, or an administrator system (e.g., used by a network administrator while evaluating a security policy posture, etc.), etc. Notification module 245 may also provide an indication of an active measure to be implemented or a recommendation for an active measure to be implemented (e.g., a recommendation for handling the traffic to/from the candidate domain based on the domain classification, etc.).

System 200 may use notification module 245 to provide to one or more security entities (e.g., a firewall), nodes, or endpoints (e.g., a client terminal) an update to an allowlist of domains, such as an allowlist of IP addresses (e.g., IP addresses from which HTTP requests originate) or an allowlist of domain signatures (e.g., hashes for domains deemed to be benign), or an update to an allowlist of DNS records. According to various embodiments, system 200 obtains a hash, signature, or other unique identifier associated with the candidate record (e.g., a triplet based on the rrname, rrdata, and rrtype), and provides an indication to the requesting entity (e.g., the security entity, node, or endpoint requesting the DNS record classification) an indication of record classification for the requesting entity to handle traffic associated with records (e.g., DNS responses) for candidate records deemed to be DNS hijacking based at least in part on the hash, signature, or other unique identifier associated with the candidate record.

In some embodiments, system 200 obtains a hash, signature, or other unique identifier associated with the candidate domain, and provides an indication to the requesting entity (e.g., the security entity, node, or endpoint requesting the domain classification) an indication of domain classification for the requesting entity to handle traffic to/from the domain (e.g., enforces a security policy) for candidate domains deemed to be DNS hijacking or otherwise malicious domains based at least in part on the hash, signature, or other unique identifier associated with the candidate domain.

System 200 may use notification module 245 to provide to one or more security entities (e.g., a firewall), nodes, or endpoints (e.g., a client terminal) an update to a denylist of DNS records to comprise a DNS records deemed to be DNS hijacking records, or to update a denylist of domains for domains classified as DNS hijacked domains. For example, system 200 provides a denylist of IP addresses (e.g., IP addresses from which HTTP requests originate) or a denylist of domain signatures (e.g., hashes for domains deemed to be DNS hijacked domains or otherwise malicious). As another example, system 200 provides a denylist of triplet based on rrname, rrdata, and rrtype for the DNS records deemed to be DNS hijacking records.

A security entity or an endpoint may compute a hash of a candidate domain or record being analyzed (e.g., a domain from/to which traffic is communicated or DNS record comprised in a DNS response). The security entity or an endpoint may determine whether the computed hash corresponding to the candidate domain is comprised within a set such as an allowlist of benign domains or records, and/or a denylist of domains or records, etc. Additionally, or alternatively, the security entity can determine whether an allowlist of domains or records or a denylist of domains or records comprises the candidate domain or record. If a signature for a received candidate domain is included in the set of signatures for domains previously deemed a DNS hijack attack related, or otherwise malicious (e.g., a denylist of domains or records), the security entity or an endpoint can prevent the transmission of a DNS response comprising the DNS hijacking record (or the corresponding traffic) or prevent traffic to/from a DNS hijacked domain, or otherwise enforce a security policy.

In some embodiments, system 200 comprises security enforcement module 247. System 200 uses security enforcement module 247 to enforce one or more security policies with respect to information such as network traffic, files, etc. System 200 may use security enforcement module 247 to perform an active measure with respect to the network traffic associated with the DNS records, such as a DNS response associated with a particular DNS record (e.g., a DNS record deemed to be a DNS hijacking record). The active measure may include blocking DNS responses for DNS hijacking records.

In some embodiments, system 200 may use security enforcement module 247 to perform an active measure with respect to the network traffic in response to detecting that the domain associated with the traffic is malicious or otherwise deemed to be a DNS hijacked domain. Security enforcement module 247 enforces the one or more security policies based on whether the candidate domain is determined to be part of a DNS hijacking attack/campaign or otherwise malicious. As an example, in the case of system 200 being a security entity (e.g., a firewall) or firewall, system 200 comprises security enforcement module 247. Firewalls typically deny or permit network transmission based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies. Other examples of policies include security policies such as ones requiring the scanning for threats in Incoming (and/or outgoing) email attachments, website content, files exchanged through instant messaging programs, and/or other file transfers.

According to various embodiments, storage 215 comprises one or more of record data 265, and/or model data 270. Storage 215 comprises a shared storage (e.g., a network storage system) and/or database data, and/or user activity data.

Record data 265 comprises information pertaining to one or more records. For example, record data 265 comprises the record data for the record being analyzed/classified (e.g., the candidate record associated with the record request received by record request module 227). In some embodiments, record data 265 comprises pDNS data for records (e.g., a candidate record), geolocation data, WHOIS data for domains, scan data for records, etc.

Record data 265 may further comprise information pertaining to a predicted domain classifications for domains or predicted record classifications for records, such as predictions of whether the candidate domain is a DNS hijacked domain, or whether a candidate record is a DNS hijacking record. For example, record data 265 stores an indication that the domain is a DNS hijacked domain, an indication of a likelihood that the domain is a DNS hijacked domain, an indication of a likelihood that the domain is benign/non-malicious domain (e.g., a non-DNS hijacked domain), etc. As another example, record data 265 stores an indication that a record is a DNS hijacking record, an indication of a likelihood that a record is a DNS hijacking record, etc.

Model data 270 comprises information pertaining to one or more models used to predict record classification, or to predict a likelihood that a record corresponds to a DNS hijacking record. As an example, model data 270 stores the classifier (e.g., a Random Forest machine learning model(s) such as a detection model) used in connection with classifying records.

According to various embodiments, memory 220 comprises executing application data 275. Executing application data 275 comprises data obtained or used in connection with executing an application such as an application executing a hashing function, an application to extract information from webpage content, an application to collect domain data, an application to monitor certificate logs, an application to extract information from a file, or other sample, etc. In embodiments, the application comprises one or more applications that perform one or more of receive and/or execute a query or task, generate a report and/or configure information that is responsive to an executed query or task, and/or provide to a user information that is responsive to a query or task. Other applications comprise any other appropriate applications (e.g., an index maintenance application, a communications application, a machine learning model application, an application for detecting suspicious input strings, suspicious files, an application for detecting suspicious or DNS hijacked domains, an application for detecting malicious network traffic or malicious/non-compliant applications such as with respect to a corporate security policy, a document preparation application, a report preparation application, a user interface application, a data analysis application, an anomaly detection application, a user authentication application, a security policy management/update application, etc.).

FIG. 3 is an illustration of a system for detecting DNS hijacking records according to various embodiments. In some embodiments, system 300 is implemented at least in part by system 100 of FIG. 1 and/or system 200 of FIG. 2. In some embodiments, system 300 implements at least part of process 800 of FIG. 8, process 900 of FIG. 9, process 1000 of FIG. 10, and/or process 1100 of FIG. 11, process 1200 of FIG. 12, and/or process 1300 of FIG. 13. In some embodiments, system 300 is implemented to implement a classifier (e.g., a machine learning model) to perform an ML-based DNS record classification, such as to classify whether the candidate DNS record is a DNS hijacking record.

In the example shown, system 300 provides a classification pipeline. As illustrated, the classification pipeline implements primarily six steps, including a pre-filtering, candidate selection, feature extraction, prediction generation, a post-filtering, and a classification (e.g., the determining of the final verdict based on the prediction and the post-filtering step). In some implementations, certain steps may be excluded, for example, the post-filtering step or certain aspects of the feature extraction.

As illustrated, new records are input to the classification pipeline. The new records may correspond to samples obtained by intercepting network traffic, or a periodic analysis of records. A pre-filtering module 310 obtains the new records, such as in connection with system 300 receiving a request to perform a classification(s). Pre-filtering module 310 removes records that are not going to be used to generate classifications. For example, pre-filtering module 310 removes one or more of: (a) resource records that have invalid fields (e.g., domains comprising invalid characters, IP addresses that have invalid values, etc.), (b) resource records have values that only work on local internal networks (e.g., internal domains and private or reserved IP address ranges), (c) records for certain record types, such as types of records for which the system is not configured to perform hijacking detection. Various other types of records/domains can be pre-filtered. For example, the rules for pre-filtering records may be configured by an administrator, etc.

In response to the new records being pre-filtered (e.g., by pre-filtering module 310, system 300 analyzes the remaining records to identify candidate records to be evaluated. Because system 300 may obtain tens or hundreds of millions of new records on any given day, system 300 selects those records that are more likely to be the result of hijacking to avoid false positives and to reduce computation cost. System 300 uses candidate selection module 320 to determine the candidate records to be evaluated (e.g., the records for which a classification is to be generated). In some embodiments, candidate selection module 320 implements service 400 of FIG. 4 to perform the candidate selection. In the example shown, candidate selection module 320 obtains pDNS data and geolocation data and uses such data in connection with performing the candidate selection. Candidate selection module 320 can obtain the pDNS data from pDNS dataset 370 (e.g., a third party service, or a dataset stored in a database), and geolocation data from a geolocation dataset 380 (e.g., a third party service, or a dataset stored in a database).

System 300 performs feature extraction with respect to a set of candidate records, such as those records to be candidate records by a candidate selection process (e.g., by candidate selection module 320). In response to obtaining the candidate records, system 300 uses feature extraction module 330 to extract a set of features pertaining to the candidate records (e.g., the candidate records). System 300 uses the set of features in connection with obtaining machine learning predictions. In the example shown, candidate selection module 320 obtains pDNS data (e.g., from pDNS dataset 370) and geolocation data (e.g., from geolocation dataset 380) and uses such data in connection with performing the feature extraction. For example, an extracted feature may be based at least in part on one or more of the pDNS data and the geolocation data.

According to various embodiments, the system extracts four types or groups of features. For example, the system extracts the four types/groups of features from the information pertaining to the candidate records. Three groups of features pertain to the statistics of the historical and new IP addresses and one group of features pertains to the features of the domain.

In some embodiments, the system standardizes the features, such as by removing the mean and scaling the data to unit variance. The system can then use the extracted standardized features as an input to a machine learning model to predict the class of the (rrname, rrtype, rrdata) triplets (e.g., to classify the record). Tables 1 and 2 provide examples of features that may be implemented. The system may implement all or any combination of the features listed in Tables 1 and 2. Additionally or alternatively, the system may implement other features or types of features. As an example, the statistics pertaining to certain characteristics or values can refer to one or more of the average, minimum, maximum, and standard deviation, and/or other similar types of statistical measures. The system queries a machine learning classifier to classify A records (e.g., to predict whether the record is a DNS hijacking record based on the A record), and query another machine learning model based on a set of other features to classify NS records (e.g., to predict whether the record is a DNS hijacking record based on the A records).

TABLE 1
Examples of IP features

| Feature Category | Feature | Description |
|---|---|---|
| Statistics for the | Statistics pertaining to the number of root domains | Statistics of |
| Previous IP | per IP | previously |
| | Statistics pertaining to the number of Top Level | used IP |
| | Domains (TLDs) per IP | |
| | Statistics pertaining to the resource record age per IP | |
| | Statistics pertaining to the proportion of domains per | |
| | IP that are malicious | |
| Statistics for the | Number of root domains using IP in new resource | Statistics of |
| New IP (the IP | record | IP in the new |
| rrdata that | Number of TLDs among root domains using IP in | resource record |
| is potentially | new resource record | |
| hijacking) | Average age of resource records where new IP is in | |
| | rrdata field | |
| | Proportion of domains using the IP in the new | |
| | resource record that are malicious | |
| | Number of root domains that started using the IP in | |
| | the new resource record in the past N days (where N | |
| | is a predefined positive integer) | |
| | Country Code of a particular IP address (CC) | |
| | matches domain TLD | |
| | IP is in an Autonomous System Number (ASN) not | |
| | used previously by domain | |
| | IP is in a country not used previously by domain | |
| | IP is in an Internet Service Provider (ISP) not used | |
| | previously by domain | |
| | IP is in a subregion not used previously by domain. | |
| | A subregion is an area within a larger region that can | |
| | contain multiple countries. (e.g., Central Asia) | |
| IP Statistics | Statistics of the difference between historical IPs | Comparison of |
| Comparison | and new IP in the number of root domains per IP | statistics of |
| | Statistics of the difference between historical IPs | previously |
| | and new IP in the number of TLDs per IP | used IPs and |
| | Statistics of the difference between historical IPs | IP in new |
| | and new IP in the average resource record age per IP | resource record |
| | Statistics of the difference between historical IPs | |
| | and new IP in the proportion of domains per IP that | |
| | are malicious | |
| | Statistics of the difference between historical IPs | |
| | and new IP in the integer value of the IPs | |
| Domain Features | Number of new root domains seen in the domain's | |
| | nameserver (NS) records in the past N days (where | |
| | N is a predefined positive integer) | |
| | Number of new IPs seen in the domain's A records | |
| | in the past N days (where N is a predefined positive | |
| | integer) | |
| | Number of new ISPs associated with new IPs seen | |
| | in the domain's A records in the past N days (where | |
| | N is a predefined positive integer) | |
| | Number of new subregions associated with new IPs | |
| | seen in the domain's A records in the past N days | |
| | (where N is a predefined positive integer) | |
| | Number of new RRs for the domain seen in the past | |
| | N days (where N is a predefined positive integer) | |
| | Number of rrtypes in new resource records | |
| | Age of domain | |
| | Number of subdomains for the domain | |
| | Number of IPs used by the domain | |
| | Number of/24 subnets of IPs used by the domain | |
| | Number of ISPs of IPs used by the domain | |
| | Number of countries of IPs used by the domain | |
| | Number of subregions of IPs used by the domain | |
| | Number of ASNs of IPs used by the domain | |
| | Number of IPs used by domain with a geolocation | |
| | that matches the domain's top level domain (TLD) | |
| | Number of nameservers used by the domain | |
| | Number of nameservers' root domains used by the | |
| | domain | |
| | Number of nameservers used by the domain that are | |
| | self-hosted (root domain of nameserver matches the | |
| | root domain of target) | |
| | Determination of whether TLD a ccTLD | |

TABLE 2
Examples of Nameserver features

| Feature Category | Feature | Description |
|---|---|---|
| Statistics for the | Statistics pertaining to the number of root domains | Statistics of |
| Previous Nameserver | per nameserver | previously |
| | Statistics pertaining to the number of TLDs per | used |
| | nameserver | nameservers |
| | Statistics pertaining to the average resource record | |
| | age per nameserver | |
| | Of all previous nameservers, statistics pertaining to | |
| | the number of domains using the nameserver whose | |
| | root domain matches that of the nameserver | |
| | Of all previous nameservers, statistics pertaining to | |
| | the number of domains using the nameserver whose | |
| | TLD matches that of the nameserver | |
| | Statistics pertaining to the proportion of the | |
| | nameservers per nameserver's root domain that are | |
| | malicious | |
| | Statistics pertaining to the proportion of domains per | |
| | nameserver's root domain that are malicious | |
| Statistics for new | Number of root domains using the new nameserver | Statistics of |
| nameserver (the | Number of TLDs among root domains using the new | nameserver in |
| name server rrdata | nameserver | the new |
| that is potentially | Average age of resource records where the new | resource record |
| hijacking) | nameserver is in rrdata field | |
| | Proportion of domains using the new nameserver | |
| | that are malicious | |
| | Number of root domains that started using the new | |
| | nameserver in the past N days (where N is | |
| | predefined positive integer) | |
| | For the new nameserver average number of domains | |
| | using the nameserver whose root domain matches | |
| | that of the new nameserver | |
| Nameserver | Statistics of difference between the number of root | Comparison of |
| Statistics | domains per nameserver of the previously used | statistics of |
| Comparison | nameservers and the nameserver in new resource | previously used |
| | record | nameservers and |
| | Statistics of difference between the number of TLDs | nameserver in |
| | per nameserver of the previously used nameservers | new resource |
| | and the nameserver in new resource record | record |
| | Statistics of difference between the average resource | |
| | record age per nameserver of the previously used | |
| | nameservers and the nameserver in new resource | |
| | record | |
| | Statistics of difference of the number of domains | |
| | whose root domain matches that of their | |
| | nameserver's root domain between the previously | |
| | used nameservers and the nameserver in new | |
| | resource record | |
| | Statistics of difference of the number of domains | |
| | whose TLD matches that of their nameserver's TLD | |
| | between the previously used nameservers and the | |
| | nameserver in new resource record | |
| | Statistics of difference of proportion of the | |
| | nameservers per nameserver root domain that are | |
| | malicious between the previously used nameservers | |
| | and the nameserver in new resource record | |
| | Statistics of difference of the proportion of domains | |
| | per nameserver root domain that are malicious | |
| | between the previously used nameservers and the | |
| | nameserver in new resource record | |
| Domain Features | Number of new root domains seen in the domain's | |
| | nameserver records in the past N days (where N is | |
| | predefined positive integer) | |
| | Number of new IPs seen in the domain's A records | |
| | in the past N days (where N is predefined positive | |
| | integer) | |
| | Number of new ISPs associated with new IPs seen | |
| | in the domain's A records in the past N days (where | |
| | N is predefined positive integer) | |
| | Number of new countries associated with new IPs | |
| | seen in the domain's A records in the past N days | |
| | (where N is predefined positive integer) | |
| | Number of new subregions associated with new IPs | |
| | seen in the domain's A records in the past N days | |
| | (where N is predefined positive integer) | |
| | Number of resource records for the domain seen for | |
| | the first time in the past N days (where N is | |
| | predefined positive integer) | |
| | Number of rrtypes in new resource records | |
| | Age of domain | |
| | Number of subdomains for the domain | |
| | Number of IPs used by domain | |
| | Number of/24 subnets of IPs used by the domain | |
| | Number of ISPs of IPs used by domain | |
| | Number of countries in which IPs used by domain | |
| | are located | |
| | Number of subregions in which IPs used by domain | |
| | are located | |
| | Number of IPs used by domain with a geolocation | |
| | that matches the TLD for the domain | |
| | Number of nameservers used by the domain | |
| | Number of root domains of nameservers used by the | |
| | domain | |
| | Number of nameservers used by the domain that are | |
| | self-hosted (root domain of nameserver matches the | |
| | root domain of target) | |
| | TLD is a ccTLD | |

System 300 uses a classifier to predict whether the record is a DNS hijacking record. In some embodiments, the classifier for predicting whether the record is a DNS hijacking record is a machine learning model. As an example, the machine learning model is a pretrained model. System 300 uses prediction module 340 to generate the prediction (e.g., of whether the record is a DNS hijacking record). Prediction module 340 uses the set of features extracted by the feature extraction module 330.

In the example shown, prediction module 340 obtains the prediction for a particular record(s) by querying pretrained ML model 350 based at least in part on the set of features extracted from feature extraction module 330.

The system uses the set of extracted features as inputs to a classifier (e.g., a trained machine learning model). For example, for each record, system 300 generates a feature vector that is based at least in part on the set of features for that record. The feature vector is used to query the classifier. For example, the classifier obtains the feature vector and outputs a probability between 0 and 1 (e.g., 0 representing a prediction that the record is not a DNS hijacking record, and 1 representing a prediction that the record is a DNS hijacking record). During the training and testing of the classifier (e.g., the machine learning model), the system calculates the threshold that provides the best precision for prediction while maintaining the recall performance of the classifier (e.g., the machine learning model). To set the threshold, the system is configured with a desired precision, using training data a proper threshold is set that provides that desired precision. The system uses the threshold to predict the class from probabilities. If the probability is above this threshold, the classifier (e.g., the model) will classify the record as a DNS hijacking record and if the probability is below the threshold, the classifier (e.g., the model) will classify the record (e.g., the domain) as benign.

Although machine learning models generally provide a prediction with a high confidence, the models can still be prone to false positives. Therefore, in some embodiments, system 300 uses a post-filtering to identify the records to classify DNS hijacking records. The post-filtering can be based at least in part on auxiliary information pertaining to a particular record, such as WHOIS data for the domain, data obtained by crawling the website for the domain, or the like. Various other types of auxiliary data may be implemented.

System 300 uses post-filtering module to collect the auxiliary information. System 300 can leverage auxiliary information because after performing the prediction step, very few records need to be further processed. For those records that prediction module 340 predicts as malicious (e.g., DNS hijacking), post-filtering module 360 collects further data about these cases of likely hijacking, including the collection of WHOIS data and actively crawling the website. Post-filtering module 360 is configured to classify the record based at least in part on the auxiliary information. For example, post-filtering module 360 is configured to make a final decision of whether we believe the record is deemed to be a DNS hijacking attack based at least in part on the auxiliary information. In response to determining that a record is classified as a DNS hijacking record, system 300 (e.g., post-filtering module) sends the record to a datastore to be blocked for customers. For example, system 300 updates a denylist of records based on the classification of the records as DNS hijacking records.

In some embodiments, post-filtering module 360 implements a classifier. The classifier can be a rule-based classifier, a heuristics-based classifier, a machine learning-based classifier, or any combination thereof.

Although the machine learning model or classifier used to determine predictions (e.g., by prediction module 340, such as by using pretrained ML model 350), in practice can still be prone to making false positive predictions. To address this problem, system 300 is configured to collect additional information for use in a post filtering step. Collection of this auxiliary information may be prohibitive at an earlier stage of the classification pipeline, system can collect the auxiliary data for all predicted DNS hijacking records. As an example, the latency or computational cost to collect the auxiliary information for each input record or candidate record may be prohibitive. The system can collect web content (e.g., by crawling the webpage for the domain) and WHOIS information for the post-filtering step and use such information to generate a classification. For example, if WHOIS indicates that a domain is a newly registered domain, then the system (e.g., the classifier used at the post-filtering stage) considers the records as not hijacking because such as domain does not have sufficient history to decide that a new record is hijacking or not. The post-filtering step according to the aforementioned technique is complementary to the use of pDNS data to generate predictions or to select candidate records because the pDNS data may have an incomplete history for the record, or the ownership of the pDNS may have changed recently.

In some embodiments, the system performs web crawling and content-based comparison using four DNS records to eliminate potential false positives from the set of predictions (e.g., the predictions generated by the machine learning model by prediction module 340). The four DNS records may comprise: (a) the resource record (RR) that includes the new IP address that was predicted to be a DNS hijacking record, (b) the RR from the current resolution of the domain (e.g., the current IP address), (c) the two most recent RRs (e.g., IPs) prior to the RR predicted to be a DNS hijacking record for the domain. The system uses the aforementioned DNS records to determine one or more of the following information from the above records (or any subset thereof): (i) a final document object model (DOM) content (e.g., computed as a SHA256 hash), (ii) the resource URLs and their content loaded during the web crawl (e.g., computed as a SHA256 hash), (iii) and certificates (if any) (e.g., computed as a SHA256 hash).

In some embodiments, the system compares the results of the four web crawls. For example, the system compares: (a) information obtained based on the resource record (RR) that includes the new IP address that was predicted to be a DNS hijacking record, and (b) information obtained based at least in part on one or more of: (i) the RR from the current resolution of RR (e.g., the current IP address), and (ii) the two most recent RRs (e.g., IPs) prior to the RR predicted to be a DNS hijacking record. The system attempts to identify similarities based on the comparison between information obtained by the web crawls. If the information from crawling using the IP used for hijacking equals (or within a predefined similarity threshold) information using one of the historical IP for crawling, then the system classifies the record (or an associated domain classification) as false positive and thus benign. In some embodiments, the system uses one or more of the following guidelines for identifying false positives or determining a final classification of a record (or domain): (a) the equality of the hash for final DOM content, (b), the equality of the loaded resources contents (e.g., based on the respective computed hashes), and (c) the equality of the certificates for the different IP addresses used. The equality of the certificates for different addresses may indicate the change in IP address was a result of website migration.

According to various embodiments, the system can implement a delayed filtering of the results, such as the results from the predictions generated by the prediction engine (e.g., the machine learning model), or the results from the classifications generated by the post-filtering. For example, the delayed filtering can be implemented in addition to, or as a replacement of, the post-filtering. After the system classifies (e.g., predicts) a record as being a DNS hijacking record, the system can continue to monitor its pDNS traffic. If the domain owner continues to use (e.g., over a threshold period of time) the domain for which the DNS record was previously classified as a DNS hijacking record, then system can determine that the classification was likely a false positive detection and the reclassifies the record as not being a result of a DNS hijacking attack (e.g., the record is deemed a non-DNS hijacking record). The system can correspondingly send an update of the reclassification, such as to update denylists that may be enforced by security services such as inline security entities (e.g., firewalls) The delayed filtering may improve the classifications because certain events in a lifetime of a domain that are otherwise benign can make a record change to appear as though the domain is subject to a DNS hijacking attack, for example, a domain ownership change or hosting provider change for the domain. Therefore, the delayed filtering implemented in some embodiments can improve the classification accuracy and remove these false positives.

FIG. 4 is an illustration of a service for selecting a candidate record according to various embodiments. In some embodiments, service 400 is implemented at least in part by system 100 of FIG. 1 and/or system 200 of FIG. 2. In some embodiments, service 400 implements at least part of process 800 of FIG. 8, process 900 of FIG. 9, process 1000 of FIG. 10, and/or process 1100 of FIG. 11.

In some embodiments, service 400 is implemented by candidate selection module 320.

In the example shown, service 400 obtains new records. In connection with obtaining the new records, service 400 can obtain pDNS data for the corresponding domains and rrdata (e.g., an IP address) and/or geolocation data for the corresponding rrdata (e.g., only for IP addresses). For example, service 400 collects new DNS record triplets (rname,rtype,rdata) from dataset 420. At 405, service 400 determines whether the record is indicative that the domain is associated with a newly observed hostname. For example, service 400 determines whether the rrname (e.g., obtained from the DNS record triplet) is a new hostname. In some embodiments, the rrname may be deemed a new hostname if it was first seen no more than a predefined threshold period of time (e.g., the rrname was seen at most X days ago in the pDNS data). If the rrname is a new hostname, then service 400 filters the record out and does not further analyze the record in the DNS hijacking attack classification pipeline (e.g., the record is no longer considered to be a candidate domain). For example, if the rrname is a new hostname, then the system generally does not have enough historical data about the domain name to accurately determine (e.g., predict) whether the record is a DNS hijacking record or whether the domain has been subject to a DNS hijacking attack. Additionally, in such cases, if the rrname is a new hostname the record is generally also unlikely to be a DNS hijacking record, a result of a DNS hijacking attack. Conversely, if the rrname is not a new hostname, then service 400 obtains the history of the root domain, such as all of the pDNS history of the root domain (and the history of all of its subdomains) of the rrname (e.g., from pDNS dataset 420).

If the rrdata matches any historical record, then service 400 does not deem the record (e.g., the domain) to be a candidate record (e.g., a domain for which the corresponding record is to be further evaluated, such as via a classification). For example, if the rrdata matches some historical data from the history of the root domain (or any of its subdomains), service 400 may deem the domain to be benign at least with respect to DNS hijacking attack classification. For example, service 400 deems the record to not be a DNS-hijacked record. In the case of A records (e.g., IP addresses), service 400 determines whether the/24 subnet of the IP address matches any of the/24 subnets in the history of the root domain of the rrname in the processed DNS record. If service 400 determines that there is no connection between the history of the rrname and the rrdata in the record, then service deems the record to be a candidate record (e.g., the DNS record as a candidate hijacking record for further processing).

FIG. 5 is an illustration of a system for generating simulated DNS records according to various embodiments. In some embodiments, system 500 is implemented at least in part by system 100 of FIG. 1 and/or system 200 of FIG. 2. In some embodiments, system 500 implements at least part of process 1400 of FIG. 14.

In some embodiments, system 500 is implemented by a service that trains classifiers, such as pretrained ML model 350.

According to various embodiments, the system trains a machine learning model to generate predictions of whether a record is a DNS hijacking record. The system uses labeled data to train the machine learning model. However, traditional datasets generally do not have enough examples of DNS hijacking attacks to train a model. In some embodiments, the system simulates hijacking attacks and use these simulations in connection with training a machine learning model (e.g., the ML classifier). The system can use a labeled dataset comprising a first subset comprising genuine or organic samples of DNS hijacking attacks, and a second subset comprising simulated or synthetic DNS hijacking attack samples (e.g., DNS hijacking attack samples obtained by performing the simulation).

In some embodiments, system 500 uses organic pDNS data to simulate hijacking records. Additionally, or alternatively, the system 500 uses synthetic data together with organic data to create simulated hijacking records.

In the examples shown, system 500 uses simulation pipeline 560 to simulate the DNS hijacking attacks (e.g., to generate a set of synthetic DNS hijacking attack samples). To simulate the hijacking, system 500 first collects known hijacking attack samples to inform the simulation scenarios. As an example, simulation pipeline 560 obtains the samples (e.g., organic DNS hijacking attack samples) from pDNS dataset 505. In some embodiments, system 500 uses both organic and synthetic rrname and rrdata to generate simulated records and insert simulated records into the pDNS dataset (e.g., to generate a training pDNS dataset 550 which includes organic and synthetic labeled data).

As an example, organic data may refer to data that has been observed in pDNS dataset 505 and which already has an established history in pDNS dataset 505. As an illustrative example, an organic target domain (e.g., for which system 500 can use as the rrname in the record) could be google.com or paloaltonetworks.com. An organic IP could be 8.8.8.8. In the example shown, at 510, simulation pipeline 560 collects organic target domains, such as from pDNS dataset 505. Simulation pipeline 560 can collect the organic target domains 510 based at least in part on one or more target domain classes obtained from target domain classes dataset 525. Similarly, at 515, simulation pipeline 560 collects organic attack IP addresses and nameservers (NSs). As illustrated, simulation pipeline 560 collects the organic attack IP addresses and nameservers based at least in part on pDNS data obtained from pDNS dataset 505 and one or more DNS hijacking attacker IP addresses and/or nameserver classes obtained from attacker IP and NS classes dataset 530.

In some embodiments, the system uses synthetic data in connection with training the machine learning model, such as pretrained ML model 350 used to generate predictions in system 300 of FIG. 3. As an example, the synthetic data may comprise an IP address that has never been seen in pDNS used for hijacking. In the example shown, at 520, simulation pipeline 560 generates one or more synthetic DNS hijacking attack IP addresses and/or NSs. Simulation pipeline 560 can generate the DNS hijacking attack IP addresses and/or NSs based at least in part on pDNS data obtained from pDNS dataset 505 and one or more DNS hijacking attacker IP addresses and/or nameserver classes obtained from attacker IP and NS classes dataset 530. In some embodiments, simulation pipeline 560 randomly generates data in connection with generating the simulated DNS hijacking attacks (e.g., to generate the synthetic data). As an example, to create synthetic rrdata, simulation pipeline 560 randomly generates IP addresses (or domains in case of an NS records) and removes those randomly generated results that have been seen in pDNS.

In some embodiments, system 500 (e.g., simulation pipeline 560) categorizes target domains according to their respective pDNS histories. For some domains it might be casier to detect hijacking (e.g., to detect a DNS hijacking record) because the domains may have always resolved to only one IP address in a specific country, while other domains use CDN and resolve to thousands of IPs in dozens of countries, thereby making detection of DNS hijacking harder. System 500 can classify how hard it would be to detect hijacking for a target domain based on the richness of its pDNS history, whether the domain is self-hosted, and/or whether the country code of the domain matches the IPs among other factors. Similarly, system 500 can use (e.g., consider) several different classes of rrdata to improve the robustness of the classifier to be trained. With respect to detecting DNS hijacking attacks based at least in part on rrdata, system 500 can consider the stability of records (e.g., how long the rrdata is used for rrnames), the reputation of the rrdata (e.g., a reputational score may be obtained from a third party service or community rating), and relationship between the rrdata and the rrname's history (e.g., cc, asn, isp, subregion has been seen in pDNS history).

In the example shown, at 535, simulation pipeline 560 generates DNS hijacking attack campaigns (e.g., the synthetic samples). In some embodiments, simulation pipeline 560 generates DNS hijacking attack campaigns based at least in part on one or more of the organic target domains (e.g., collected at 510), the organic attack IP addresses and NSs (e.g., collected at 515), and/or the synthetic attack IP addresses and/or NSs (e.g., collected at 520). Additionally, the DNS hijacking attack campaigns can be generated based at least in part on a set of campaign scenarios obtained from campaign scenario dataset 540.

In some embodiments, simulation pipeline 560 generates the DNS hijacking attack campaigns based at least in part on pairing organic rrnames (e.g., domains that are targeted by hijacking) and organic or synthetic rrdata to form a new hijacked record. Simulation pipeline 560 creates a large number and wide variety records combining rrnames and rrdata from different classes. In some embodiments, simulation pipeline 560 ensures to organize the created records into attack campaigns. For example, simulation pipeline 560 generates small campaigns that include one domain hijacked and attackers using one IP for hijacking. Additionally, or alternatively, simulation pipeline 560 generates large campaigns where multiple domains have been simulated as being hijacked using multiple IP addresses by the attackers. Simulation pipeline 560 can additionally generate a set of medium sized campaigns situated between small and large campaigns.

In response to generating the attack campaigns, simulation pipeline 560 inserts (e.g., stores) the generated attack campaigns (e.g., the synthetic data) into a training pDNS dataset 550, which can additionally store organic pDNS data. In the example shown, at 545, simulation pipeline 560 inserts the simulated attack campaigns (e.g., the generated attack campaigns) into training pDNS dataset 550. The ML model (e.g., the classifier) training pipeline can use these simulated records as though the simulated records were observed as normal new records.

FIG. 6 is an illustration of a system for training a classifier according to various embodiments. In some embodiments, system 600 is implemented at least in part by system 100 of FIG. 1 and/or system 200 of FIG. 2. In some embodiments, system 600 implements at least part of process 900 of FIG. 9, process 1000 of FIG. 10, process 1100 of FIG. 11, process 1200 of FIG. 12, and/or process 1300 of Figured 13.

According to various embodiments, the system uses simulated hijacking records for the hijacking labels. For example, the system uses the organic hijacking records and synthetic hijacking records obtained from training pDNS dataset 550 of system 500 as labeled data to train the ML model (e.g., the classifier for predicting whether a domain/record is a DNS hijacking attack).

In some embodiments, the system can use all new records from a time period (e.g., two weeks or some other predefined time period) to be used as not-hijacking labeled data (e.g., as benign records). The intuition behind using these new records collected over a predefined period is that only a few records out of hundreds of thousands of new records are expected to be DNS hijacking records, thus the benign labels are mostly correct. This much imprecision can easily be tolerated by the process used to train a machine learning model (e.g., the ML classifier).

In the example shown, in order to create feature vectors for the labeled records, system 600 passes the labeled records through the first three stages (or similarly configured stages) of the same pipeline that is used to generate a prediction (e.g., the pipeline implemented by system 300 of FIG. 3). Accordingly, system 506 obtains a set of new records from new record dataset 610 and a set of simulated hijacking attacks (or a combination of organic and synthetic hijacking attacks) from hijacking attacks dataset 605 and passes the set of new records and the set of simulated hijacking records through a candidate selection module 625. Candidate selection module 625 may be the same as, or similar to, candidate selection module 320. As shown, candidate selection module 625 can obtain pDNS data from pDNS dataset 615 and geolocation data from geolocation dataset 620, and use the pDNS data and geolocation data in connection with performing candidate selection (e.g., determining the candidate domains/records).

In some embodiments, system 600 additionally prefilters the set of new records and the set of simulated hijacking records, such as by using a pre-filtering module that is the same as, or similar to, pre-filtering module 310 of system 300. For example, system 600 can prefilter the set of new records and the set of simulated hijacking records before performing candidate selection (e.g., passing the records through candidate selection module 625).

System 600 extracts a set of features for those records not filtered in by the pre-filtering or candidate selection. For example, system 600 uses feature extraction module 630 to extract features for those records deemed to be candidate records by candidate selection module 625. As illustrated, feature extraction module 630 extracts the set of features based at least in part on pDNS data (e.g., obtained from pDNS dataset 615) and geolocation data (e.g., obtained from gcolocation dataset 620). In some embodiments, feature extraction module 630 is similar to, or the same as, feature extraction module 330.

System 600 stores the features extracted from the candidate domains/records into labeled features dataset 635. The set of features stored in labeled features dataset 635 can be used in connection with training the ML model (e.g., the classifier to predict whether a record is a DNS hijacking record).

In the example shown, system 600 uses training module 640 to train the ML model. Training module 640 can implement a training pipeline to train the ML model. The training pipeline can comprise two steps: (i) a data preparation and/or cleaning step; and (ii) a training step. During data preparation, training module 640 obtains a set of feature vectors and removes any non-numerical values. Additionally, training module 640 can also replace the missing values with the mean of the data observed for that feature. Such a process can be referred to as missing value imputation which can be implemented according to various techniques. Additionally, training module 650 standardizes the features in the set of features by rescaling the features, such as to ensure the features respectively have a mean of zero and standard deviation of 1. The rescaling of the features can be important because some machine learning algorithms are sensitive to the scale of input data.

During the training phase, training module 640 uses the set feature vectors (e.g., the feature vectors based at least in part on the processed/prepared features) and their corresponding labels are used as inputs to train one or more machine learning models, which can then be stored in pretrained ML models dataset 645. The machine learning models can be trained according to various machine learning techniques. Examples of machine learning processes/techniques that can be implemented to train machine learning model include decision tree classifier, AdaBoost, k-nearest neighbors (KNN), neural networks and Random Forest. Various other types of machine learning processes may be implemented. In some embodiments, the machine learning model (e.g., the classifier used to generate a prediction of whether a record is a DNS hijacking record, such as pretrained ML model 350) is a Random Forest model. The type of machine learning process to be implemented to train the machine learning model can be selected based on the process that results in a machine learning model that returns the highest accuracy or F1-score.

In some embodiments, training module 640 implements a hyperparameter turning. For hyperparameter tuning, system 600 can perform a grid search on various parameter values on part of the data. Examples of these parameters (e.g., in the case of a Random Forest classifier) that can be tuned/grid searched include imputing strategy, number of estimators, the maximum depth of the tree, minimum sample split, minimum sample leaf, and whether bootstrap samples are used to build the trees. Various other types of parameters may be implemented.

In connection with training/determining the machine learning model to be implemented to generate predictions/classification of whether a record is a DNS hijacking record (e.g., whether domain is a DNS hijacked domain), system 600 performs testing. System 600 can use testing module 650 to obtain the set of machine learning models generated by training module 640 and stored in pretrained ML models dataset 645. In some embodiments, training module 640 performs a 5 fold cross validation for testing the performance of the model. At each fold, 80% of the data is used for training and 20% of the data is kept aside for testing. At the end of the cross validation, the average performance of the 5-folds is reported as the performance of the corresponding model. This performance is an estimate on how the model performs on unseen data.

According to various embodiments, system 600 randomly split the data (e.g., the labeled features) into 90% for training and 10% for testing. However, various other ratios may be implemented. In some embodiments, system 600 train a Random Forest model on 90% of the data and searches for the threshold that results in the highest accuracy/F1-score and use the threshold on the test data (e.g., the 10% of data not used for training) to calculate expected precision and recall values.

In response to training the model, the trained model is stored as the selected ML model 660 to be used in a detection pipeline (e.g., to generate predictions of whether a record is a DNS hijacking record).

FIG. 7 is a flow diagram of a method for classifying a record according to various embodiments. In some embodiments, process 700 is implemented at least in part by system 100 of FIG. 1 and/or system 200 of FIG. 2. Process 700 may be implemented by an inline security entity.

In some implementations, process 700 may be implemented by one or more servers, such as in connection with providing a service to a network (e.g., a security entity and/or a network endpoint such as a client device). In some implementations, process 700 may be implemented by a security entity (e.g., a firewall) such as in connection with enforcing a security policy with respect to traffic from/to domains across a network or in/out of the network. In some implementations, process 700 may be implemented by a client device such as a laptop, a smartphone, a personal computer, etc., such as in connection with executing or opening a file such as an email attachment.

At 705, the system obtains passive DNS (pDNS) data pertaining to a set of resource records. At 710, the system extracts a first set of features based at least in part on the pDNS data for a selected resource record. At 715, the system uses a classifier to determine whether a candidate record is a DNS hijacking record (e.g., that a domain associated with the selected resource is subject to a DNS hijacking). At 720, the system performs an active measure. The active measure may include blocking DNS responses for the DNS record deemed to be a DNS hijacking record. At 725, a determination is made as to whether process 700 is complete. In some embodiments, process 700 is determined to be complete in response to a determination that no further records are to be analyzed (e.g., no further predictions for records are needed), no further resource records are obtained, no further traffic is to be classified, an administrator indicates that process 700 is to be paused or stopped, etc. In response to a determination that process 700 is complete, process 700 ends. In response to a determination that process 700 is not complete, process 700 returns to 705.

FIG. 8 is a flow diagram of a method for classifying a record according to various embodiments. In some embodiments, process 800 is implemented at least in part by system 100 of FIG. 1 and/or system 200 of FIG. 2. Process 800 may be implemented by a security entity.

In some implementations, process 800 may be implemented by one or more servers, such as in connection with providing a service to a network (e.g., a security entity and/or a network endpoint such as a client device). In some implementations, process 800 may be implemented by a security entity (e.g., a firewall) such as in connection with enforcing a security policy with respect to traffic from/to domains across a network or in/out of the network. In some implementations, process 800 may be implemented by a client device such as a laptop, a smartphone, a personal computer, etc., such as in connection with executing or opening a file such as an email attachment.

At 805, the system obtains a set of records. The system queries a pDNS dataset for the pDNS data/records for the set of records.

At 810, the system selects a candidate records(s) from the set of records. In some embodiments, the system selects candidate records based at least in part on a determination that the hostname for the record is not a newly observed hostname and/or the IP in the candidate record is not in the/24 subnets of the root domain of the domain in the candidate record.

At 815, the system extracts a set of features from information pertaining to the candidate records(s).

At 820, the system uses a classifier to obtain a prediction(s) of whether the candidate record(s) is subject to a DNS hijacking. In some embodiments, the classifier is a machine learning-based classifier (e.g., a machine learning model trained using a machine learning process). As an example, the machine learning-based classifier is trained using a training set of pDNS data which includes at least a subset of simulated pDNS records for simulated attack campaigns. The training set includes simulated pDNS records because of the limited ground truth available (e.g., less than a hundred hijacking records are generally found in pDNS data, which is not enough for training and testing) and/or because many real DNS hijacking attacks are very similar (e.g., the training using such ground truth data would be biased towards these specific attacks).

In some embodiments, the system uses ground truth data only as a guideline and for final testing. The system obtains more hijacking labeled data, by including simulated hijacking attacks. The simulated hijacking attacks are based on real hijacking attacks and include more variability among the attacks to allow for robust classification.

At 825, the system performs a post-filtering on the prediction(s) to obtain a classification(s) for the candidate record(s). In some embodiments, the post-filtering is performed for classifications. The post-filtering may include using WHOIS data and/or webpage crawled data to determine which of the candidate records predicted to be subject to DNS hijacking are to be classified as DNS hijacking records.

According to various embodiments, the system implements a post-filtering to increase the confidence of the verdicts (e.g., the classifications), particularly to reduce the number of potential false positives. The post-filtering may include performing a comparative analysis of the web contents hosted on the hijacking and the original addresses. Serving potentially malicious or deceiving content increases the confidence in the hijacking verdict (e.g., the classification that the record is a DNS hijacking record). Additionally, the post-filtering may include determining whether the rrdata for the record persists over a duration of time (e.g., a threshold period of time). For domains for which the rrdata persists over a threshold period of time the system changes the verdict to benign (e.g., uses a classification of benign rather than the prediction that the record is a DNS hijacking record) because of the property that DNS hijacking attacks are generally short-lived.

At 830, the system provides an indication of the classification(s). For example, the system returns the indication of the set of features to the system or service that invoked process 800. In some embodiments, the providing the indication the classification(s) includes updating an allowlist or denylist based on the classifications and deploying the allowlist or denylists at other network nodes, such as security entities or client systems.

At 835, a determination is made as to whether process 800 is complete. In some embodiments, process 800 is determined to be complete in response to a determination that no further records are to be analyzed (e.g., no further predictions for records are needed), no further resource records are obtained, no further traffic is to be classified, an administrator indicates that process 800 is to be paused or stopped, etc. In response to a determination that process 800 is complete, process 800 ends. In response to a determination that process 800 is not complete, process 800 returns to 805.

FIG. 9 is a flow diagram of a method for selecting candidate records according to various embodiments. In some embodiments, process 900 is implemented at least in part by system 100 of FIG. 1 and/or system 200 of FIG. 2. Process 900 may be implemented by a security entity.

In some implementations, process 900 may be implemented by one or more servers, such as in connection with providing a service to a network (e.g., a security entity and/or a network endpoint such as a client device). In some implementations, process 900 may be implemented by a security entity (e.g., a firewall) such as in connection with enforcing a security policy with respect to traffic from/to domains across a network or in/out of the network. In some implementations, process 900 may be implemented by a client device such as a laptop, a smartphone, a personal computer, etc., such as in connection with executing or opening a file such as an email attachment.

At 905, the system obtains an indication to select candidate records from a set of records. In some embodiments, process 900 is invoked by process 700 (e.g., at 710) and/or process 800 (e.g., at 810). At 910, the system obtains pDNS data pertaining to the set of resource records. At 915, the system obtains geo-location data pertaining to the set of records. At 920, the system selects candidate record(s) from the set of records based at least in part on the pDNS data and the geo-location data pertaining to the set of records. At 925, the system provides an indication of the candidate records. For example, the system returns the indication of the set of features to the system or service that invoked process 900. At 930, a determination is made as to whether process 900 is complete. In some embodiments, process 900 is determined to be complete in response to a determination that no further records are to be analyzed (e.g., no further candidate records are to be identified, or no further records are to be evaluated to identify whether they are candidate records), no further resource records are obtained, no further traffic is to be classified, an administrator indicates that process 900 is to be paused or stopped, etc. In response to a determination that process 900 is complete, process 900 ends. In response to a determination that process 900 is not complete, process 900 returns to 905.

FIG. 10 is a flow diagram of a method for selecting candidate records according to various embodiments. In some embodiments, process 1000 is implemented at least in part by system 100 of FIG. 1 and/or system 200 of FIG. 2. Process 1000 may be implemented by a security entity.

In some implementations, process 1000 may be implemented by one or more servers, such as in connection with providing a service to a network (e.g., a security entity and/or a network endpoint such as a client device). In some implementations, process 1000 may be implemented by a security entity (e.g., a firewall) such as in connection with enforcing a security policy with respect to traffic from/to domains across a network or in/out of the network. In some implementations, process 1000 may be implemented by a client device such as a laptop, a smartphone, a personal computer, etc., such as in connection with executing or opening a file such as an email attachment.

At 1005, the system obtains an indication to select candidate records from a set of records. In some embodiments, process 1000 is invoked by process 700 (e.g., at 710) and/or process 800 (e.g., at 810), process 900 (e.g., at 920).

At 1010, the system obtains pDNS data pertaining to the set of resource records.

The pDNS data can include the respective DNS record triplets of (rrname, rrtype, and rrdata) for the set of resource records.

At 1015, the system selects a resource record.

At 1020, the system determines whether the hostname for the selected resource record is newer than a threshold period of time. For example, the system determines whether the rrname corresponds to hostname that is new. A hostname may be deemed a new hostname if it was first seen at most a threshold number of days ago in the pDNS records/data. The system uses the newness of a hostname in the selection of candidate records because if a hostname is new it is hard to reliably detect DNS hijacking for the corresponding record.

In response to determining that the hostname for the selected resource record is newer than the threshold period of time, process 1000 proceeds to 1025 at which the selected resource record is filtered (e.g., filtered out from further consideration as a candidate domain). Thereafter, process 1000 proceeds to 1035.

Conversely, in response to determining that the hostname for the selected resource record is not newer than the threshold period of time, process 1000 proceeds to 1035 at which the system does not filter the selected resource record and considers it for further processing. For example, the system maintains the selected resource record as a record for further evaluation as to whether the record is a candidate record.

At 1035, the system determines whether another resource record is to be evaluated. For example, the system determines whether the set of resource records comprises one or more other resource records to be evaluated. In response to determining that another resource record is to be evaluated, process 1000 returns to 1015 and process 1000 iterates over 1015-1035 until no further resource records are to be evaluated. Conversely, in response to determining that no further resource records are to be evaluated, process 1000 proceeds to 1040.

At 1040, the system obtains pDNS data for a root domain of the selected record and one or more its sub-domains. The system can obtain all historical pDNS data for a domain, or alternatively, can obtain historical pDNS data for a predefined period of time. The obtaining the pDNS data for the root name and one or more subdomains includes obtaining information pertaining to the/24 subnets of these domains.

At 1045, the system determines whether f (rrdata) from the pDNS data for the selected record matches any pDNS history (at least within a predefined look-back period of time), where f (rrdata) is results from performing a function f with respect to the rrdata. For example, the system checks whether a/24 subnet of the IP address matches any of the/24 subnets in the history of the root domain (and its subdomains) of the rrname. The system can determine whether rrdata of the selected record matches any pDNS history to determine whether there is any connection between the history of the rrname and the rrdata in the record.

In response to determining that the rrdata of the selected record matches a record in the pDNS historical data for the record, process 1000 proceeds to 1050 at which the system filters the selected record. For example, the system filters the domain out from further consideration as a candidate record. Thereafter, process 1000 proceeds to 1060.

In response to determining that the rrdata for the selected record matches a record in the pDNS historical data for the domain, process 1000 proceeds to 1055 at which the system sets the selected record as a candidate record.

At 1060, the system determines whether another record (e.g., to be evaluated as a candidate record). In response to determining that another record(s) is to be evaluated, process 1000 proceeds to 1040 and process 1000 iterates over 040-1060 until no further records are to be evaluated. Conversely, in response to determining that no further records are to be evaluated, process 1000 proceeds to 1065.

At 1065, the system provides an indication of the candidate record(s). For example, the system returns the indication of the set of candidate records to the system or service that invoked process 1000.

At 1070, a determination is made as to whether process 1000 is complete. In some embodiments, process 1000 is determined to be complete in response to a determination that no further records are to be analyzed (e.g., no further candidate records are to be identified, or no further records are to be evaluated to identify whether they are candidate records), no further resource records are obtained, no further traffic is to be classified, an administrator indicates that process 1000 is to be paused or stopped, etc. In response to a determination that process 1000 is complete, process 1000 ends. In response to a determination that process 1000 is not complete, process 1000 returns to 1005.

Although the example shown in FIG. 10 illustrates the iteratively processing the records one-by-one, in various embodiments, a plurality of records may be processed in parallel.

For example, the plurality of records may be processed in a big data processing setting with highly parallelized computation (e.g., using Google's SQL like BigQuery).

FIG. 11 is a flow diagram of a method for performing feature extraction for a candidate domain according to various embodiments. In some embodiments, process 1100 is implemented at least in part by system 100 of FIG. 1 and/or system 200 of FIG. 2. Process 1100 may be implemented by a security entity.

In some implementations, process 1100 may be implemented by one or more servers, such as in connection with providing a service to a network (e.g., a security entity and/or a network endpoint such as a client device). In some implementations, process 1100 may be implemented by a security entity (e.g., a firewall) such as in connection with enforcing a security policy with respect to traffic from/to domains across a network or in/out of the network. In some implementations, process 1100 may be implemented by a client device such as a laptop, a smartphone, a personal computer, etc., such as in connection with executing or opening a file such as an email attachment.

At 1105, the system obtains an indication to extract features for a candidate domain. In some embodiments, process 1100 is invoked by process 700 (e.g., at 710) and/or process 800 (e.g., at 815). At 1110, the system obtains pDNS data pertaining to the candidate record. For example, the system queries a pDNS dataset for the pDNS data for the candidate records. The pDNS dataset may be hosted by a third party service. At 1115, the system obtains geo-location data pertaining to the candidate record. At 1120, the system extracts a set of features for the candidate record based at least in part on pDNS data and the geo-location domain. As an example, the system extracts a feature that is based on the number of IP addresses used by a domain with a geolocation that matches the domain's top level domain (TLD). At 1125, the system provides an indication of the set of features. For example, the system returns the indication of the set of features to the system or service that invoked process 1100. At 1130, a determination is made as to whether process 1100 is complete. In some embodiments, process 1100 is determined to be complete in response to a determination that no further records are to be analyzed (e.g., no further records are to be identified), no further resource records are obtained, no further features are to be extracted, no further traffic is to be classified, an administrator indicates that process 1100 is to be paused or stopped, etc. In response to a determination that process 1100 is complete, process 1100 ends. In response to a determination that process 1100 is not complete, process 1100 returns to 1105.

FIG. 12 is a flow diagram of a method for performing a post-filtering for classifying a candidate domain according to various embodiments. In some embodiments, process 1200 is implemented at least in part by system 100 of FIG. 1 and/or system 200 of FIG. 2. Process 1200 may be implemented by a security entity.

In some implementations, process 1200 may be implemented by one or more servers, such as in connection with providing a service to a network (e.g., a security entity and/or a network endpoint such as a client device). In some implementations, process 1200 may be implemented by a security entity (e.g., a firewall) such as in connection with enforcing a security policy with respect to traffic from/to domains across a network or in/out of the network. In some implementations, process 1200 may be implemented by a client device such as a laptop, a smartphone, a personal computer, etc., such as in connection with executing or opening a file such as an email attachment.

At 1205, the system obtains an indication to post-filter a prediction for a candidate records(s). For example, process 1200 may be invoked by process 800, such as at 825, or be process 700, such as at 715. At 1210, the system selects a candidate records. At 1215, the system obtains an indication of the prediction for the selected candidate record. At 1217, the system determines whether the selected candidate record is predicted to be a DNS hijacking record. In response to determining that the selected candidate record is predicted to be a DNS hijacking record, process 1200 proceeds to 1220. Conversely, in response to determining that the selected candidate record is not predicted to be a DNS hijacking record, process 1200 proceeds to 1240. At 1220, the system obtains a set of auxiliary information for the selected record. In some embodiments, the set of auxiliary information comprises WHOIS data for the selected record, website crawled data obtained by crawling the website for the selected record (e.g., the webpage hosted at the domain associated with the selected record). Additionally, the set of auxiliary information may include other types of information pertaining to the selected record. At 1225, the system queries a post-filtering classifier to obtain a classification for the candidate record.

The post-filtering classifier may be a machine learning-based classifier, a rule-based classifier, a heuristics-based classifier, or the like, or some combination of the foregoing. As an example, the post-filtering classifier can generate the classification based on determining a likelihood that the record is a DNS hijacking record and comparing the likelihood to a predefined DNS hijacking threshold, and determining the record to be a DNS hijacking record if the predicted likelihood is greater than the predefined DNS hijacking threshold. As another example, the post filtering classifier can generate the classification based at least in determining that the auxiliary information satisfies one or more rules or heuristics. At 1230, the system determines whether predictions for one or more other candidate domains are to be post-filtered. In response to determining that predictions for one or more other candidate records are to be post-filtered, process 1200 returns to 1210 and process 1200 iterates over 1210-1230 until no further predictions are to be filtered. Conversely, in response to determining that no further predictions for candidate records are to be post-filtered, process 1200 proceeds to 1235. At 1235, the system provides the classification for the candidate record(s). At 1240, a determination is made as to whether process 1200 is complete. In some embodiments, process 1200 is determined to be complete in response to a determination that no further records are to be analyzed (e.g., no further candidate records are to be identified, or no further records are to be evaluated to identify whether they are candidate records), no further resource records are obtained, no further classifications are to be generated for candidate records, no further traffic is to be classified, an administrator indicates that process 1200 is to be paused or stopped, etc. In response to a determination that process 1200 is complete, process 1200 ends. In response to a determination that process 1200 is not complete, process 1200 returns to 1205.

FIG. 13 is a flow diagram of a method for training a model according to various embodiments. In some embodiments, process 1300 is implemented at least in part by system 100 of FIG. 1 and/or system 200 of FIG. 2.

At 1305, information pertaining to a set of historical DNS hijacked domains or records (or historical DNS hijacking campaigns) is obtained. In some embodiments, the system obtains the information pertaining to a set of historical known DNS hijacked domains or records known internally or from a third-party service (e.g., VirusTotal™). The system may obtain a set of historical samples of known DNS hijacking campaigns from a third party service. In some embodiments, set of historical DNS hijacked domains or records (or historical DNS hijacking campaigns) comprises a set of simulated DNS hijacking campaigns, such as simulated DNS records corresponding to simulated DNS hijacking campaigns that are generated using the technique implemented by system 500 of FIG. 5. At 1310, information pertaining to a set of historical known non-DNS hijacked domains or records is obtained. In some embodiments, the system obtains the information pertaining to a set of historical known non-DNS hijacked domains or records from a third-party service (e.g., VirusTotal™). At 1315, one or more relationships between characteristic(s) of domains or records and indications that the candidate domains or records are malicious DNS hijacked domains or records. For example, the system determines a set of features to be used by a classifier (e.g., a machine learning model) to classify candidate domains or records. At 1320, a model for determining whether a domain is a DNS hijacked domain or whether a record is a DNS hijacking record. The model may be a machine learning model. For example, the model is trained using a machine learning process. Examples of machine learning processes that can be implemented in connection with training the model include random forest, support vector machine, naive Bayes, logistic regression, K-nearest neighbors, decision trees, gradient boosted decision trees, etc. In some embodiments, the model is trained using a long short-term memory networks (LSTM) model. At 1325, the model is deployed. In some embodiments, the deploying of the model includes storing the model in a dataset of models for use in connection with analyzing traffic to determine whether the traffic is to/from a DNS hijacked domain or pertaining to a DNS hijacking record (e.g., a DNS response that includes the DNS hijacking record). Deploying the model can include providing the model (or a location at which the model can be invoked) to a malicious traffic detector, such as DNS record classifier 170 of system 100 of FIG. 1, or to system 200 of FIG. 2. At 1330, a determination is made as to whether process 1300 is complete. In some embodiments, process 1400 is determined to be complete in response to a determination that no further models are to be determined/trained (e.g., no further classification models are to be created), an administrator indicates that process 1300 is to be paused or stopped, etc. In response to a determination that process 1300 is complete, process 1300 ends. In response to a determination that process 1300 is not complete, process 1300 returns to 1305.

FIG. 14 is a flow diagram of a method for detecting malicious traffic according to various embodiments. In some embodiments, process 1400 is implemented at least in part by system 100 of FIG. 1 and/or system 200 of FIG. 2. Process 1400 may be implemented by a security entity.

In some implementations, process 1400 may be implemented by one or more servers, such as in connection with providing a service to a network (e.g., a security entity and/or a network endpoint such as a client device). In some implementations, process 1400 may be implemented by a security entity (e.g., a firewall) such as in connection with enforcing a security policy with respect to traffic from/to domains across a network or in/out of the network. In some implementations, process 1400 may be implemented by a client device such as a laptop, a smartphone, a personal computer, etc., such as in connection with executing or opening a file such as an email attachment.

At 1405, an indication that the candidate record is a DNS hijacking record is received. In some embodiments, the system receives an indication that a candidate a record is a DNS hijacking record, and the domain or hash, signature, or other unique identifier associated with the record. For example, the system may receive the indication that the candidate record is a DNS hijacking record from a service such as a security or malware service. The service implements a classification of records, and can maintain an allowlist or denylist of records for traffic handling. The system may receive the indication that the record is a DNS hijacking record from one or more servers.

According to various embodiments, the indication that the candidate record is a DNS hijacking record is received in connection with an update to a set of previously identified DNS hijacking records. For example, the system receives the indication that the candidate record is a DNS hijacking record as an update to a denylist of records.

At 1410, an association of the candidate record with an indication that the record isa DNS hijacking record is stored. In response to receiving the indication that the record is a DNS hijacking record, the system stores the indication that the record is a DNS hijacking record in association with the record or an identifier corresponding to the record to facilitate a lookup (e.g., a local lookup) of whether subsequently received traffic includes a DNS hijacking record. In some embodiments, the identifier corresponding to the record stored in association with the indication that the record is a DNS hijacking record comprises a hash of the domain or DNS record triplet, a signature of the DNS record triplet, or another unique identifier associated with the DNS record triplet.

At 1415, DNS traffic is received. The system may obtain DNS traffic such as in connection with routing traffic within/across a network, or mediating traffic into/out of a network such as a firewall, or a monitoring of email traffic or instant message traffic. The traffic may be obtained based on the inline security entity monitoring application traffic or network traffic.

At 1420, a determination of whether the traffic comprises a DNS hijacking record is performed. In some embodiments, the system obtains a sample record from the received traffic. In response to obtaining a record from the traffic, the system determines whether the record corresponds to a record comprised in a set of previously identified DNS hijacking records. In response to determining that the sample record is in the set of previously identified DNS hijacking records, the system determines that the sample record is a DNS hijacking record.

In some embodiments, the system determines whether the record corresponds to a record comprised in a set of previously identified benign records such as an allowlist of non-DNS hijacking records. In response to determining that the sample record is comprised in the set of records on the allowlist of non-hijacked records, the system determines that the record is not a DNS hijacking record.

According to various embodiments, in response to determining the candidate record is not comprised in a set of previously identified DNS hijacking records (e.g., a denylist of DNS hijacking records) or a set of previously identified benign records (e.g., an allowlist of non-DNS hijacking records), the system queries a DNS hijacking record detector to determine whether the candidate record is a DNS hijacking record, such as by storing the record in a set of records collected over a predefined period of time that had not yet been analyzed. The DNS hijacking record detector may correspond to DNS record classifier 170 of system 100 of FIG. 1.

In response to a determination that the traffic does not correspond to traffic for a DNS hijacking record at 1420, process 1400 proceeds to 1430 at which traffic for the record is handled as non-DNS hijacking record traffic.

Conversely, in response to a determination that the traffic corresponds to traffic for a DNS hijacking record at 1420, process 1400 proceeds to 1425 at which traffic for the record is handled as DNS-hijacked record traffic/information. The system may handle the DNS-hijacked record based at least in part on one or more policies such as one or more security policies. For example, the system blocks DNS responses for a DNS-hijacked record.

According to various embodiments, the handling of the DNS hijacking record may include performing an active measure. The active measure may be performed in accordance with (e.g., based at least in part on) one or more security policies. As an example, the one or more security policies may be preset by a network administrator, a customer (e.g., an organization/company) to a service that provides detection of DNS hijacking records, etc. Examples of active measures that may be performed include: isolating the traffic such as DNS responses for DNS hijacking records, deleting the traffic, prompting the user to alert the user that a DNS hijacking record was detected, providing a prompt to a user when the a device attempts to open access the domain associated with a DNS hijacking record, blocking transmission of information to/from the domain associated with the DNS hijacking record, updating a denylist of DNS hijacking records.

At 1435, a determination is made as to whether process 1400 is complete. In some embodiments, process 1400 is determined to be complete in response to a determination that no further records are to be analyzed (e.g., no further predictions for records are needed), an administrator indicates that process 1400 is to be paused or stopped, etc. In response to a determination that process 1400 is complete, process 1400 ends. In response to a determination that process 1400 is not complete, process 1400 returns to 1405.

Various examples of embodiments described herein are described in connection with flow diagrams. Although the examples may include certain steps performed in a particular order, according to various embodiments, various steps may be performed in various orders and/or various steps may be combined into a single step or in parallel. For example, some steps may be performed in parallel asynchronously.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
one or more processors configured to:
obtain passive DNS (pDNS) data pertaining to a set of resource records;
extract a first set of features based at least in part on the pDNS data for a selected resource record, wherein the selected resource record is selected from the set of resource records;
use a classifier to determine whether a candidate record corresponding to the selected resource record is a result of a DNS hijacking based at least in part on the first set of features; and
perform an active measure in response to determining that the candidate record is the result of the DNS hijacking; and
a memory coupled to the one or more processors and configured to provide the one or more processors with instructions.

2. The system of claim 1, wherein the classifier is a machine learning model.

3. The system of claim 1, wherein performing the active measure in response to determining that the candidate record is a result of the DNS hijacking comprises:
applying a security policy based on a classification of the candidate record as a being a result of the DNS hijacking.

4. The system of claim 3, wherein the applying the security policy comprises:
handling network traffic to/from the candidate domain based at least in part on (i) a classification that the candidate record is a result of the DNS hijacking, and (ii) the security policy.

5. The system of claim 3, wherein the applying the security policy comprises blocking a DNS response in response to a determination that the DNS response comprises a DNS hijacking record.

6. The system of claim 1, wherein:
the one or more processors are further configured to:
obtain geo-location data pertaining to the candidate record;
extract a second set of features based at least in part on the geo-location pertaining to the candidate record; and
the classifier determines whether the candidate record is a result of the DNS hijacking based at least in part on the first set of features and the second set of features.

7. The system of claim 1, wherein the classifier is trained based at least in part on simulated DNS hijacking records.

8. The system of claim 8, wherein the simulated DNS hijacking records are inserted into a pDNS dataset used to train the classifier.

9. The system of claim 7, wherein the simulated DNS hijacking records are generated based at least in part on:
obtaining a set of known DNS hijacking records;
obtaining a set of organic target domains;
obtaining a set of organic attack IP addresses and nameserver records;
obtaining synthetic attack IP addresses and nameserver records; and
generating one or more attack campaigns to obtain the simulated DNS hijacking records.

10. The system of claim 8, wherein the synthetic IP addresses and nameserver records are obtained based at least in part on:
randomly generating a set of IP addresses; and
filtering the set of IP addresses to remove IP addresses that are comprised in a pDNS dataset to obtain a set of synthetic IP addresses.

11. The system of claim 10, wherein the one or more attack campaigns are generated based at least in part on pairing a set of organic target domains with a set comprising a subset of organic IP addresses and a subset of synthetic IP addresses.

12. The system of claim 6, wherein the simulated DNS hijacking records are generated based at least in part on:
obtaining a set of known DNS hijacking records;
obtaining a set of organic target domains;
obtaining a set of organic A resource record data (rrdata) and nameserver rrdata;
obtaining synthetic attack A rrdata and nameserver rrdata; and
generating one or more attack campaigns to obtain the simulated DNS hijacking records.

13. The system of claim 12, wherein the synthetic A records and nameserver records are obtained based at least in part on:
randomly generating a set of rrdata; and
filtering the set of rrdata to remove rrdata that are comprised in a pDNS dataset to obtain a set of synthetic rrdata.

14. The system of claim 1, wherein using the classifier to determine whether the candidate record is a result of the DNS hijacking based at least in part on the first set of features comprises:
querying a machine learning model to obtain a prediction based at least in part on the first set of features; and
in response to obtaining the prediction, performing a post-filtering to obtain the classification, wherein the post-filtering is based at least in part on one or more of (i) WHOIS data for the candidate domain, and (ii) website content for the candidate domain.

15. The system of claim 1, wherein:
the pDNS data for the candidate record comprises at least a DNS record triplet comprising (rrname, rrtype, rrdata); and
the candidate resource record is selected based at least in part on a determination that the rrname is not a new hostname.

16. The system of claim 15, wherein the one or more processors are further configured to:
in response to determining that the rrname is not a new hostname,
obtain pDNS historical data for (i) a root domain of the rrname, and (ii) subdomains of the root domain;
determine whether a function f of the rrdata for the candidate record matches any historical record after applying function f to rrdata comprised in the pDNS historical data; and
in response to determining that the function f of the rrdata for the candidate record does not match function f of any historical rrdata comprised in the pDNS historical data, select the selected record.

17. The system of claim 16, wherein the function f of the rrdata comprises calculating the subnet portion of a corresponding IP address.

18. The system of claim 1, wherein the classifier performs a set of classifications at predetermined intervals.

19. A method, comprising:
obtaining passive DNS (pDNS) data pertaining to a set of resource records;
extracting a first set of features based at least in part on the pDNS data for a selected resource record, wherein the selected resource record is selected from the set of resource records;
using a classifier to determine whether a candidate record corresponding to the selected resource record is a result of a DNS hijacking based at least in part on the first set of features; and
performing an active measure in response to determining that the candidate record is the result of the DNS hijacking.

20. A computer program product embodied in a non-transitory computer readable medium and comprising computer instructions for:
obtaining passive DNS (pDNS) data pertaining to a set of resource records;
extracting a first set of features based at least in part on the pDNS data for a selected resource record, wherein the selected resource record is selected from the set of resource records;
using a classifier to determine whether a candidate record corresponding to the selected resource record is a result of a DNS hijacking based at least in part on the first set of features; and
performing an active measure in response to determining that the candidate record is the result of the DNS hijacking.

21. A system, comprising:
one or more processors configured to:
obtain a set of training candidate records;
obtain a set of pDNS data for the set of training candidate records, the set of pDNS data comprising data for a set of organic DNS records and data for a set of simulated DNS hijacking records;
perform a machine learning process to generate a hijacked domain classifier based at least in part on the set of pDNS data for the set of training candidate records; and
deploy the hijacked domain classifier in a system to perform detection of hijacked domains; and
a memory coupled to the one or more processors and configured to provide the one or more processors with instructions.
